(19) United States
(12) Patent Application Publication
(10) Pub. No.: US 2024/0221207 A1
(43) Pub. Date: Jul. 4, 2024

(54) ELECTRONIC DEVICE AND METHOD FOR PROVIDING CONTENT IN VIRTUAL SPACE

(71) Applicants: Samsung Electronics Co., Ltd., Suwon-si (KR); Sungkyul University Industry-University Cooperation Foundation, Anyang-si (KR)

(72) Inventors: Doil KWON, Suwon-si (KR); Sangsoon LIM, Seoul (KR); Hansin KOH, Suwon-si (KR); Sheungmin OH, Goyang-si (KR); Seulbi SHIN, Osan-si (KR); Seoyeoung HONG, Incheon (KR)

(21) Appl. No.: 18/402,219

(22) Filed: Jan. 2, 2024

(30) Foreign Application Priority Data
Jan. 2, 2023 (KR) 10-2023-0000399
Apr. 11, 2023 (KR) 10-2023-0047740

(51) Int. Cl. G06T 7/73; G06T 17/00; G06V 10/44

(52) U.S. Cl. CPC G06T 7/73; G06T 17/00; G06V 10/44; G06T 2207/20044

(57) ABSTRACT

An electronic device for providing content in a virtual space obtaining an image is provided. The electronic device includes a user, obtain, from the image, first position information indicating the positions of a plurality of feature points indicating a specific part of the user's body, check whether a posture of the user included in the image corresponds to a preset response pose, based on the first position information, and determine the content to be provided in the virtual space, based on whether the user's posture corresponds to the preset response pose.

### CROSS-REFERENCE TO RELATED APPLICATION(S)

This application is based on and claims priority under 35 U.S.C. § 119(a) of a Korean patent application number 10-2023-0000399, filed on Jan. 2, 2023, in the Korean Intellectual Property Office, and of a Korean patent application number 10-2023-0047740, filed on Apr. 11, 2023, in the Korean Intellectual Property Office, the disclosure of each of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) Samsung Electronics Co., Ltd., and 2) Sungkyul University Industry-University Cooperation Foundation.

### BACKGROUND

### 1. Field

The disclosure relates to an electronic device and method for providing content in a virtual space.

### 2. Description of the Related Art

In order to determine the degree of immersion of an audience in content such as a performance, a movie, an exhibition, and the like, the audience's satisfaction and interest may be determined through a questionnaire or direct questioning after the performance. Because a questionnaire or direct questioning may be conducted after a performance ends, it is difficult to organize performance content in a flexible way by considering the degree of immersion of an audience during the performance.

Recently, as the area of content has expanded, performances are taking place in virtual spaces. In a virtual space, users may watch a performance through individual electronic devices. In addition, in the case of a performance taking place in a virtual space, a screen provided to users may include not only a performance on-the-scene screen, but also an audience screen that displays the users.

Therefore, when the degree of immersion of an audience in content is immediately determined, there is an advantage in that an audience screen on which users are displayed in a virtual space may be flexibly organized depending on the degree of immersion of the audience. In other words, the quality of a performance may be improved by diversely organizing content in a virtual space, the content being provided to users.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and method for providing content in virtual space.

Additional aspects will be set forth in part in the description which follows and, in part, will be apparent from the description, or may be learned by practice of the presented embodiments.

In accordance with an aspect of the disclosure, an electronic device providing content in a virtual space is provided. The electronic device includes a memory and at least one processor. The memory stores at least one instruction. The at least one processor is configured to execute the at least one instruction stored in the memory. The at least one processor executing the at least one instruction cause the electronic device to obtain an image including a user, obtain, from the image, first position information indicating the positions of a plurality of feature points indicating a specific part of the user's body, check whether a posture of the user included in the image corresponds to a preset response pose, based on the first position information, determine the content to be provided in the virtual space, based on whether the user's posture corresponds to the preset response pose.

In accordance with another aspect of the disclosure, a method for providing content in a virtual space is provided. The method includes obtaining an image including a user. The method includes obtaining, from the image, first position information indicating the positions of a plurality of feature points indicating a specific part of the user's body. The method includes checking whether a posture of the user included in the image corresponds to a preset response pose, based on the first position information. The method includes determining the content to be provided in the virtual space, based on whether the user's posture corresponds to the preset response pose.

In accordance with another aspect of the disclosure, a non-transitory computer-readable recording medium having recorded thereon a program executed by at least one process to perform a method of providing content in a virtual space is provided. The method comprising the operations of obtaining an image including a user, obtaining, from the image, first position information indicating positions of a plurality of feature points indicating a specific part of the user's body, checking whether a posture of the user included in the image corresponds to a preset response pose, based on the first position information, and determining the content to be provided in the virtual space, based on whether the user's posture corresponds to the preset response pose.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view of a method, performed by an electronic device, of providing content in a virtual space, according to an embodiment of the disclosure;

FIG. 2 is a flowchart for describing an operation in which an electronic device provides content in a virtual space, according to an embodiment of the disclosure;

FIG. 3 is a flowchart for describing an operation of a system of providing content to an external device that uses a virtual space, according to an embodiment of the disclosure;

FIG. 4 is a diagram for describing a method, performed by an electronic device, of obtaining a feature point for recognizing a user's posture from a user image, according to an embodiment of the disclosure;

FIG. 5 is a diagram for describing a method, performed by an electronic device, of recognizing a user's posture by using a feature point, according to an embodiment of the disclosure;

FIG. 6 is a diagram for describing a method, performed by an electronic device, of determining content according to whether a user's posture corresponds to a preset response pose, according to an embodiment of the disclosure;

FIG. 7 is a flowchart for describing an operation in which an electronic device detects a user's posture, based on a feature point, according to an embodiment of the disclosure;

FIG. 8 is a flowchart for describing an operation in which an electronic device provides content in a virtual space, according to an embodiment of the disclosure;

FIG. 9 is a flowchart for describing an operation in which an electronic device determines the degree of response of a user, according to an embodiment of the disclosure;

FIG. 10 is a diagram for describing a method, performed by an electronic device, of providing content in a virtual space, according to an embodiment of the disclosure;

FIG. 11 is a flowchart for describing an operation in which an electronic device determines content based on the degree of response of a user, according to an embodiment of the disclosure;

FIG. 12 is a flowchart for describing an operation in which an electronic device transmits a data stream to display content through an external device, according to an embodiment of the disclosure;

FIG. 13 is a diagram for describing a method, performed by an electronic device, of recognizing a user's posture by using link information, according to an embodiment of the disclosure;

FIG. 14 is a diagram for describing a method, performed by an electronic device, of recognizing a user's posture by using link information, according to an embodiment of the disclosure;

FIG. 15 is a block diagram showing a configuration of an electronic device according to an embodiment of the disclosure;

FIG. 16 is a detailed block diagram showing a configuration of an electronic device according to an embodiment of the disclosure; and

FIG. 17 is a diagram showing a system that provides a virtual space, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Throughout the disclosure, the expression “at least one of a, b, or c” indicates only a, only b, only c, both a and b, both a and c, both b and c, all of a, b, and c, or variations thereof.

All terms including descriptive or technical terms which are used in embodiments of the disclosure should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of the disclosure. Therefore, the terms used in the disclosure should not be interpreted based on only their names but have to be defined based on the meaning of the terms together with the descriptions throughout the specification.

As used herein, the singular forms are intended to include the plural forms as well, unless the context clearly indicates otherwise. All terms including descriptive or technical terms which are used herein should be construed as having meanings that are obvious to one of ordinary skill in the art. While terms, such as “first,” “second,” etc., used herein may be used to describe various components, such components should not be limited to the above terms. The above terms are used only to distinguish one component from another.

Throughout the disclosure, when a part “includes” or “comprises” an element, unless there is a particular description contrary thereto, the part may further include other elements, not excluding the other elements. As used in the specification, the term “unit” or “module” denotes an entity for performing at least one function or operation, and may be implemented as hardware, software, or a combination of hardware and software.

Hereinafter, the disclosure will now be described more fully with reference to the accompanying drawings for one of ordinary skill in the art to be able to perform embodiments of the disclosure without difficulty. The disclosure may, however, be embodied in many different forms and should not be construed as being limited to the embodiments of the disclosure set forth herein. In addition, portions irrelevant to the description are omitted from the drawings for clarity, and like components are denoted by like reference numerals throughout the specification. In addition, reference numerals used in each drawing are only for describing each drawing, and different reference numerals used in each of different drawings are not intended to indicate different elements. Hereinafter, the disclosure will be described in detail with reference to the accompanying drawings.

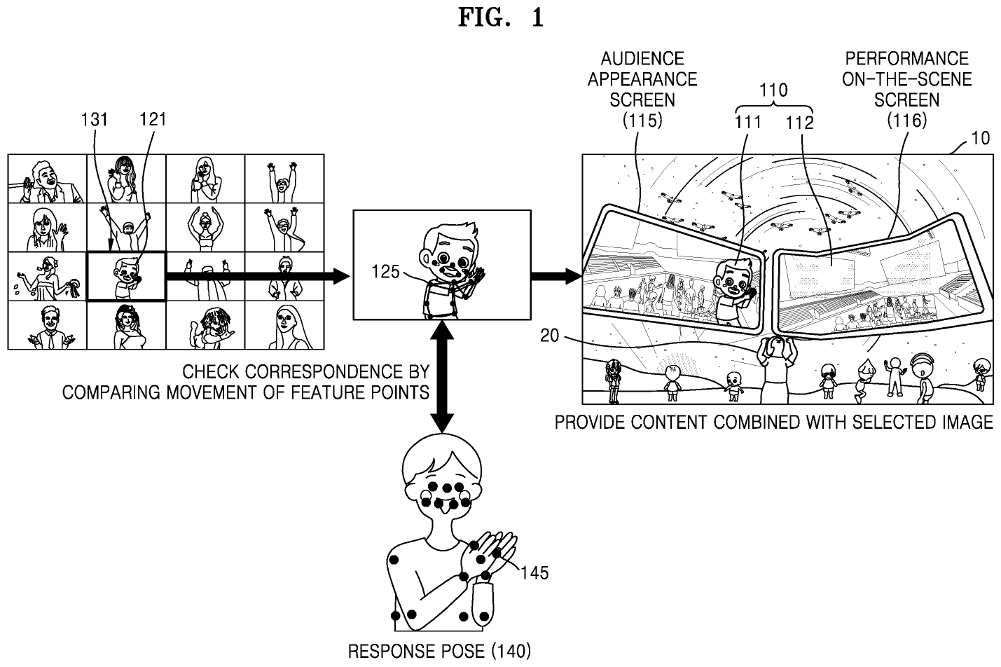

FIG. 1 is a schematic view of a method, performed by an electronic device, of providing content in a virtual space, according to an embodiment of the disclosure.

Referring to FIG. 1, an electronic device according to an embodiment of the disclosure may provide content 110 in a virtual space 10. The electronic device may provide the content 110 to a user.

In the disclosure, content may refer to content related to various experiences, such as a performance, education, work, and entertainment, which may be provided in a virtual space. In the disclosure, content is described by focusing on the meaning of performance content provided in a virtual space, but this is merely an example, and the meaning of content is not limited thereto.

The virtual space 10 refers to a virtual environment that a user may access and experience by using an Internet-connected device, such as a computer, a mobile terminal, and a virtual reality headset. Users who have accessed a virtual space may explore the virtual space 10 in various ways and interact with each other. The virtual space 10 may be simulated as a two-dimensional world or may be simulated as a three-dimensional world.

In the virtual space 10, a user 121 may watch the content 110 provided from the electronic device according to an embodiment of the disclosure. At the same time, the user 121 may create an avatar 20 that is a digital representation of themselves, and may interact with another avatar in the virtual environment.

The content 110 provided by the electronic device according to an embodiment of the disclosure may be combined with a user image 131. The user 121 may react to the content 110 through an avatar and simultaneously share the user's own reaction with other users through the content 110 combined with the user image 131.

For reference, the electronic device according to an embodiment of the disclosure provides the content 110 or live performance content 112 to a user and then provides to the user the content 110 combined with the user image 131 of the user's reaction to receiving the content 110 or the live performance content 112. However, the electronic device may perform such operations in real time. In other words, the electronic device may provide the content 110 combined with the user image 131 to a user in real time and simultaneously control content in real time, such as changing the combined image into another user image.

The electronic device may provide the content 110 to a user through a communication interface. The user may receive the content 110 from the electronic device by using an external device and watch the content 110.

In an embodiment of the disclosure, the external device may provide, to the user 121, the content 110 received from the electronic device. The external device may include, but is not limited to, a computer, a mobile terminal, a television (TV), a smart monitor, a tablet personal computer (PC), a laptop, a large display, a 360-degree projector, and the like.

In an embodiment of the disclosure, the electronic device may obtain the user image 131 showing a posture of the user who has received the content 110.

For example, the electronic device receives the user image 131 including the user. The user image 131 may include the user's upper body. The user image 131 may be, for example, an image captured by a camera.

In an embodiment of the disclosure, the posture of the user may refer to a reaction that occurs while the user is watching the provided content 110. For example, the user image 131 includes an image of a user in various postures, such as a user waving their hand while watching the content 110, a user clapping, a user covering their mouth, a user spreading their arms, a user dancing, a user in a stationary posture, and the like.

In an embodiment of the disclosure, the electronic device may obtain first position information indicating the positions of a plurality of feature points 125 indicating a specific part of the user's body from the received user image 131.

The electronic device may obtain a feature point related to a main point of the user's body from the user image 131. The feature point may correspond to the position of a main point of a person's body and may be arranged like a feature point 145 in an illustrated response pose 140. The electronic device may obtain a feature point related to the user's upper body. The electronic device may use the first position information to obtain information about movement of a joint of the user within the user image 131.

In an embodiment of the disclosure, the electronic device may check whether a posture of the user 121 included in the user image 131 corresponds to the preset response pose 140, based on the first position information. The electronic device may detect whether the user assumes a specific pose, based on the first position information about the positions of the plurality of feature points 125 based on the user image 131.

The electronic device may preset a reference pose and the response pose 140 related to a pose that appears when the user responds to the content 110, and may store the preset response pose 140 and reference pose.

In an embodiment of the disclosure, the electronic device may detect whether a posture of the user in the user image 131 corresponds to the preset response pose 140, by comparing the first position information with second position information.

The first position information may be information about a change in the position of a feature point that may be obtained by comparing the user image 131 with the reference pose. The first position information may be information indicating the positions of a plurality of feature points corresponding to a posture of the user in the user image 131, based on a plurality of feature points in the reference pose.

The second position information may be information about the position of a feature point that may be obtained by comparing the preset response pose 140 with the reference pose. The second position information may be information indicating the positions of a plurality of feature points corresponding to the preset response pose 140, based on a plurality of feature points in the reference pose.

In an embodiment of the disclosure, the electronic device may detect whether a posture of the user corresponds to the preset response pose 140 by using a response degree determination module and may obtain a response degree that is the degree of response of the user to the content 110. The response degree determination module may be a deep-learning model that classifies a posture of the user based on a change in the position of a feature point of the input user image 131 and outputs the degree of response according to the classified posture. For example, the response degree determination module includes a deep-learning model including at least one of a long short-term memory (LSTM) model or an attention model.

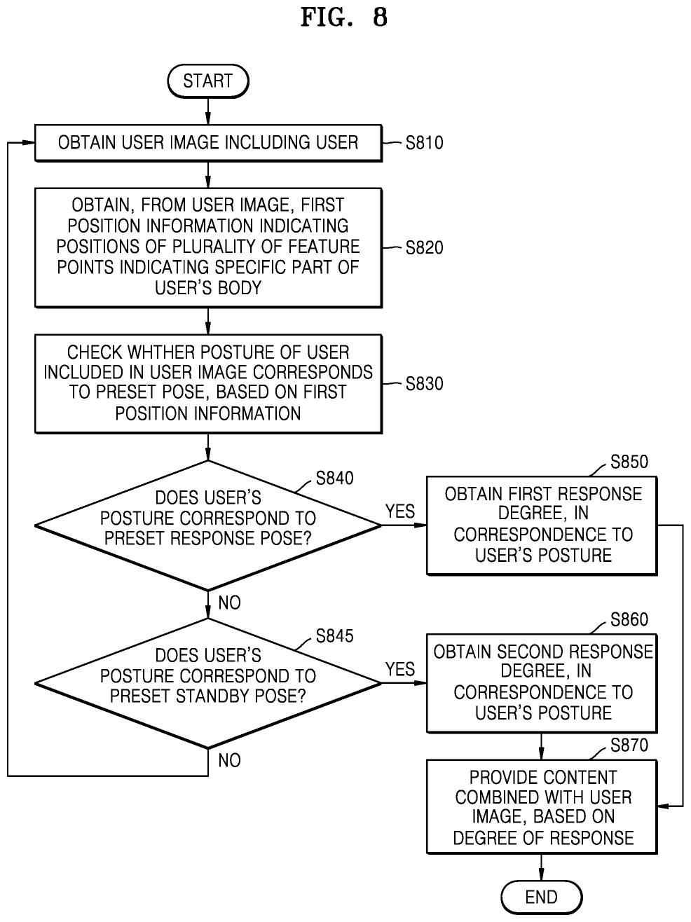

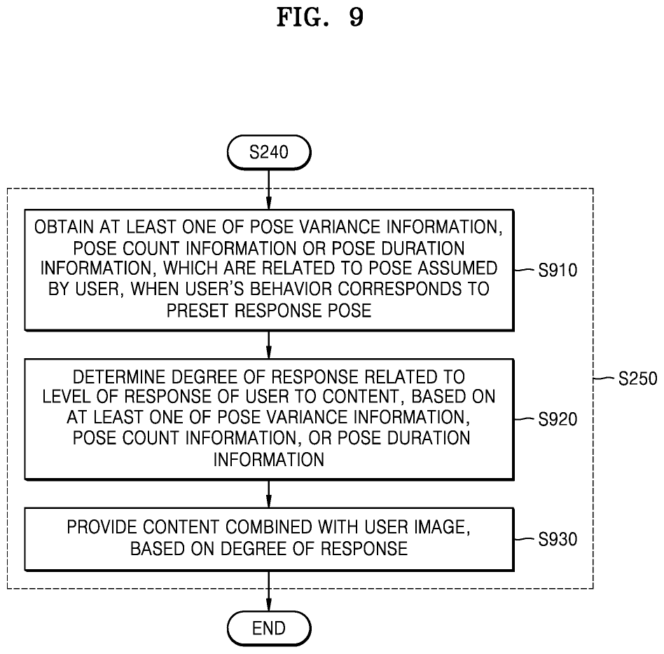

The electronic device may determine the corresponding degree of response when the user 121 assumes a specific pose. The degree of response may be used to select a user image to be combined with the content 110. A method, performed by the electronic device, of determining the degree of response is described in detail with reference to FIGS. 8 and 9.

In an embodiment of the disclosure, the electronic device may select a first user image 131 with a high degree of response among a plurality of received user images. The electronic device may provide the content 110 combined with the selected first user image 131 to a user.

The electronic device may determine the degree of response corresponding to each of the plurality of user images, based on postures of a plurality of users, and may select the first user image 131 with a high degree of response among the plurality of user images. The electronic device may combine the first user image 131 with the content 110 and provide the content 110 combined with the first user image 131 to a user.

In an embodiment of the disclosure, the electronic device may provide the content 110 through a first region 115 and a second region 116 in the virtual space. As shown, the first region 115 may refer to an audience appearance screen, and the second region 116 may refer to a performance on-the-scene screen. As shown, the first region 115 and the second region 116 may be separated from each other, but this is merely an example, and the technical concept of the disclosure is not limited thereto. For example, the first region 115 may be part of the second region 116.

The content 110 may include live performance content 112 and audience appearance content 111. The live performance content 112 may be displayed through the performance on-the-scene screen implemented in the virtual space. The live performance content 112 may refer to content related to various experiences intended to be provided to a user. For example, the live performance content 112 is an image of a performance being relayed in real time.

The audience appearance content 111 may be displayed through the audience appearance screen implemented in the virtual space. The audience appearance content 111 may refer to content that displays a reaction of a user watching the live performance content 112. For example, the audience appearance content 111 includes the first user image 131 determined to have a high degree of response based on postures of a plurality of users. The electronic device may display the first user image 131 through the audience appearance screen.

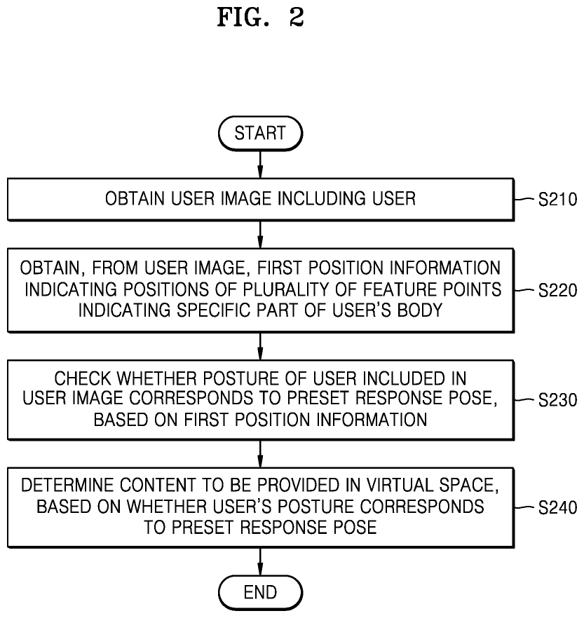

FIG. 2 is a flowchart for describing an operation in which an electronic device provides content in a virtual space, according to an embodiment of the disclosure.

Referring to FIG. 2, in operation S210, the electronic device may obtain a user image including a user.

In an embodiment of the disclosure, the electronic device may provide content to a user by using a communication interface. The electronic device may transmit the content to an external device. For example, the external device includes a computer, a mobile terminal, a TV, and the like. The user may watch content provided by the electronic device through the external device. The electronic device may obtain a user image showing a posture of the user who has received the content. In an embodiment of the disclosure, the electronic device is a server that provides content to a user terminal and allows the user terminal to display the provided content in a virtual space.

In an embodiment of the disclosure, the user image may be an image of the user captured by a camera. The user image may include the user's upper body.

In operation S220, the electronic device may obtain first position information indicating the positions of a plurality of feature points indicating a specific part of the user's body.

The electronic device may collect a plurality of position coordinates of a plurality of feature points corresponding to a person's joints in an image or a video. For example, the electronic device collects position coordinates of a body part including at least one of the hands, elbows, shoulders, waist, hip, neck, face, knees, ankles, or feet.

The first position information may be information about the position of a feature point that may be obtained by comparing the user image with a reference pose. The first position information may be information indicating the positions of a plurality of feature points corresponding to a posture of the user in the user image, based on a plurality of feature points in the reference pose.

In an embodiment of the disclosure, the electronic device may preset the reference pose related to a basic posture of a person. The electronic device may store reference position coordinates of a feature point corresponding to the reference pose when the person's body assumes the reference pose. For example, the reference pose is a standing-at-attention posture.

For example, the feature point refers to a plurality of feature points and may include a first feature point among the plurality of feature points. The electronic device may obtain position coordinates of the first feature point on the user's body at a specific moment in the user image, based on position coordinates of the first feature point in the reference pose. The first position information may include information indicating the position coordinates of the first feature point on the user's body at a specific moment in the user image, by using the position coordinates of the first feature point in the reference pose as an origin point.

For reference, a method of obtaining the first position information is described by focusing on one feature point, but the first position information includes a plurality of pieces of data for each of a plurality of feature points. In addition, the method of obtaining the first position information is described based on a specific moment in the user image, but the user image may refer to a series of images over a certain period of time, and the first position information may include a plurality of pieces of position information for each moment.

In an embodiment of the disclosure, the electronic device may obtain the first position information about a feature point indicating a specific part of the user in the user image, by using a user behavior recognition module.

The user behavior recognition module may be an artificial intelligence model that estimates a person's posture in a video or an image. The user behavior recognition module may be a model trained to estimate a person's posture based on the person's important body part. For example, the user behavior recognition module estimates a person's posture based on movement of the person's joint.

In an embodiment of the disclosure, the electronic device may obtain a feature point of the user's upper body from among the collected plurality of position coordinates. For example, the feature point includes position coordinates of the user's body part including the hands, elbows, shoulders, waist, hip, neck, and face.

For example, users participating a virtual space often sits in a specific space. In this case, the captured user image of the user may be an image obtained by limitedly capturing the user's upper body. By extracting a feature point related to the user's upper body from the plurality of position coordinates of the person's joint, the amount of data to be processed by a processor of the electronic device may be reduced, and high-speed computation may be possible.

In operation S230, the electronic device may check whether a posture of the user included in the user image corresponds to a preset response pose, based on the first position information.

In an embodiment of the disclosure, the electronic device may check whether the posture of the user corresponds to the preset response pose, by comparing the first position information with second position information.

The electronic device may further obtain the second position information about the position of a feature point in the preset response pose. The second position information may be information indicating the positions of a plurality of feature points in the preset response pose. The electronic device may preset a response pose related to a pose that appears when the user responds to content, and may store the preset response pose and position coordinates of a plurality of corresponding feature points in a memory.

The second position information may be information about the position of a feature point that may be obtained by comparing the preset response pose with the reference pose. The second position information may be information indicating the positions of a plurality of feature points corresponding to the preset response pose, based on a plurality of feature points in the reference pose. The electronic device may obtain the second position information by comparing position coordinates related to movement of a feature point in the reference pose with position coordinates related to movement of a feature point in the preset response pose.

The electronic device may detect how similar or different a posture of the user in the user image is to or from the preset response pose, by comparing the first position information with the second position information. In other words, the electronic device may detect the user's posture by comparing the position of a feature point according to a posture of the user in the user image with the position of a feature point according to the preset response pose.

In an embodiment of the disclosure, the response pose may include a clapping pose, a cheering pose, an arm-opening pose, a dancing pose, and a one-hand-raising pose, but the type of response pose is merely an example and does not limit the technical concept of the disclosure. For example, the response pose also includes a pose where the hand is placed at a chest level to raise the hand as a preparation posture for raising one hand.

In an embodiment of the disclosure, the reference pose may include a standby posture. In detail, the reference pose may include a posture of standing up straight with both arms pointing down toward the ground. However, the reference pose is determined to be a posture that is used as a reference, and does not limit the technical concept of the disclosure. For example, the electronic device sets a cheering pose as the reference pose.

In an embodiment of the disclosure, the electronic device may detect that the user has assumed a pose corresponding to the response pose, by using a response degree determination module. The response degree determination module may include a deep learning model that receives an input of an image to detect and classify a posture of a person and output the degree of response according to the classified posture. For example, the response degree determination module includes a deep learning model including at least one of an LSTM model or an attention model.

In operation S240, the electronic device may determine content to be provided in a virtual space, based on whether the posture of the user corresponds to the preset response pose.

In an embodiment of the disclosure, the electronic device may select at least one user image among a plurality of user images. The electronic device may determine the content to be provided in the virtual space by using the selected at least one user image. For example, the electronic device combines the selected at least one user image with the content and provide the combined content to the user. The electronic device may display the selected at least one user image by allocating a partial region of the virtual space and display the content through another partial region of the virtual space.

In an embodiment of the disclosure, the electronic device may determine that the posture of the user in the user image corresponds to the preset response pose. When the posture of the user corresponds to the preset response pose, the electronic device may match, to the user image, a first response degree indicating a high degree of response of the user to content. The electronic device may combine the user image corresponding to the first response degree with the content and provide the combined content to the user.

In an embodiment of the disclosure, the electronic device may determine that the posture of the user in the user image does not correspond to the preset response pose. When the posture of the user does not correspond to the preset response pose, the electronic device may match, to the user image, a second response degree indicating a low degree of response of the user to the content. The electronic device may combine the user image corresponding to the second response degree with the content and provide the combined content to the user.

However, whether or not to combine is merely an example and does not limit the technical concept of the disclosure. For example, a user image to be combined is selected according to the purpose and intent of the content. When a content producer wants to combine a user image of a highly responsive user with content, the electronic device may combine a user image corresponding to the first response degree with the content and may not combine a user image corresponding to the second response degree with the content. The electronic device may provide the combined content to the user.

In an embodiment of the disclosure, the electronic device may detect that the posture of the user in the user image corresponds to the preset response pose, and may determine the degree of response by using at least one of pose variance information, pose count information or pose duration information, which are related to a pose assumed by the user. Descriptions thereof are provided in detail by using operation S910 and operation S920 of FIG. 9.

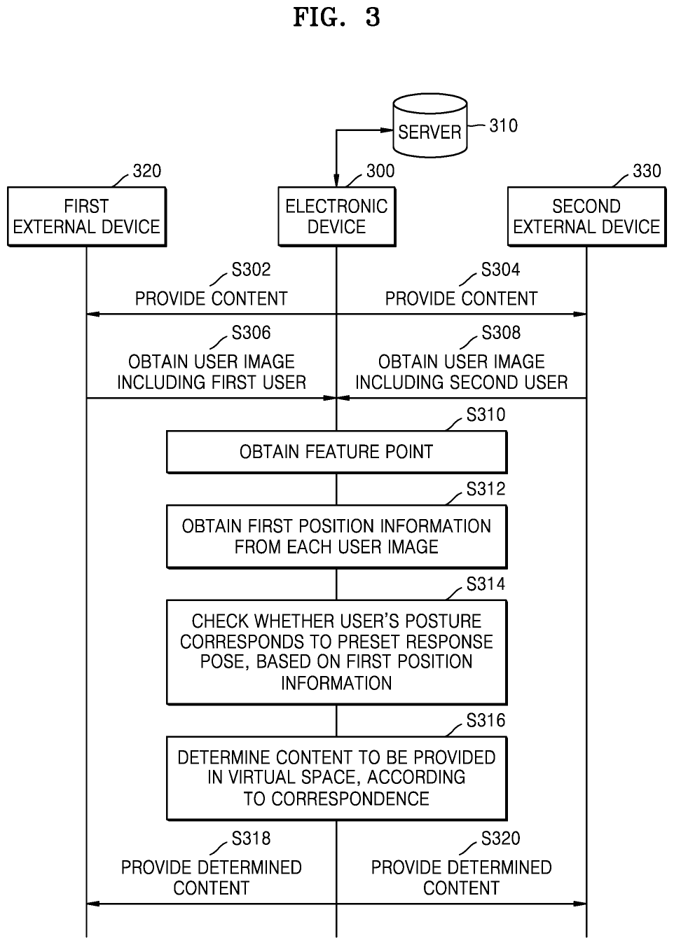

FIG. 3 is a flowchart for describing an operation of a system of providing content to an external device that uses a virtual space, according to an embodiment of the disclosure.

For convenience of description, those redundant to the descriptions of FIG. 2 are briefly described or are not provided.

Referring to FIG. 3, in an embodiment of the disclosure, a system that implements a virtual space may at least include a first external device 320, a second external device 330, an electronic device 300, and a server 310.

In an embodiment of the disclosure, the electronic device 300 may provide content to an external device that uses the virtual space. The electronic device 300 may provide the content to the first external device 320 in operation S302. The electronic device 300 may provide the content to the second external device 330 in operation S304. Each user may watch the content provided by using their own terminal. In addition, each user may use the virtual space including the content provided by using their own terminal. For example, each user moves the user's avatar within the virtual space or communicate (e.g., public chat) within the virtual space by using a terminal.

In an embodiment of the disclosure, the electronic device 300 may obtain a user image including a first user from the first external device 320 in operation S306. The electronic device 300 may obtain a user image including a second user from the second external device 330 in operation S308. The user image may be an image showing a posture of a user who has received the content.

The user image may include an image captured by a camera mounted into an external device. The user image may include an image of the first user captured by a camera mounted into the first external device 320. The user image may include an image of the second user captured by a camera mounted into the second external device 330. The user image may include a captured image of a user's upper body.

In an embodiment of the disclosure, the electronic device 300 may obtain a feature point related to a user's upper body in operation S310.

The electronic device 300 may obtain a feature point related to a user's upper body from a plurality of user images. As shown, the electronic device 300 may obtain a feature point of the first user's upper body from the user image of the first user. The electronic device 300 may obtain a feature point of the second user's upper body from the user image of the second user.

In an embodiment of the disclosure, the electronic device 300 may obtain first position information about the position of a feature point, based on each user image in operation S312. Descriptions of operation S312 are redundant to the descriptions of operation S220 of FIG. 2 and thus are not provided.

In an embodiment of the disclosure, the electronic device 300 may check whether a posture of a user corresponds to a preset response pose, based on the first position information in operation S314.

In detail, the electronic device 300 may obtain second position information about the position of a feature point corresponding to the preset response pose. The electronic device 300 may check whether the posture of the user corresponds to the preset response pose, by comparing the second position information with the first position information.

Descriptions of operation S314 are redundant to the descriptions of operation S230 of FIG. 2 and thus are not provided.

In an embodiment of the disclosure, the electronic device 300 may determine content to be provided in a virtual space according to whether the posture of the user corresponds to the preset response pose in operation S316.

For example, the electronic device 300 determines the degree of response related to the degree of response of the user to the content, based on whether the posture of the user corresponds to the preset response pose. The electronic device 300 may obtain the degree of response corresponding to each of a plurality of user images. The electronic device 300 may select a user image with a high degree of response among the plurality of user images. The electronic device 300 may combine the selected user image with the content.

As another example, the electronic device 300 obtains the degree of response corresponding to each of a plurality of user images. The electronic device 300 may list the plurality of user images according to a ranking of the degrees of response. The electronic device 300 may select at least two user images with a high degree of response among the plurality of user images. The electronic device 300 may combine the selected at least two user images with the content.

In an embodiment of the disclosure, the electronic device 300 may provide the combined content to the user. The electronic device 300 may provide the combined content to the user through the first external device 320 in operation S318. The electronic device 300 may provide the combined content to the user through the second external device 330 in operation S320.

For example, the electronic device 300 provides content combined with a user image to a user. As shown in FIG. 1, the electronic device may provide content including the live performance content 112 and the audience appearance content 111 to a user, and the selected user image may be displayed as the audience appearance content 111 through the audience appearance screen.

As another example, the electronic device 300 provides the content combined with the at least two user images to the user. Although FIG. 1 illustrates the content combined with one user image, the electronic device 300 may provide content including the live performance content 112 and the audience appearance content 111 to the user, and the selected at least two user images may be displayed as the audience appearance content 111 through the audience appearance screen.

Meanwhile, the electronic device 300 according to an embodiment of the disclosure may communicate with the server 310. The electronic device 300 may transmit/receive data used in the above-described operations to/from the server 310. In this case, at least part of data processing performed in the above-described operations may be performed by the server 310.

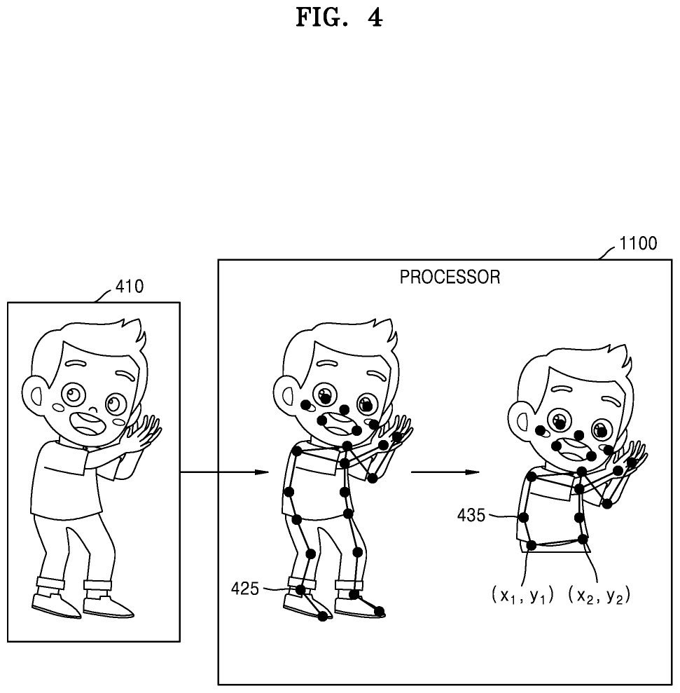

FIG. 4 is a diagram for describing a method, performed by an electronic device, of obtaining a feature point for recognizing a user's posture from a user image, according to an embodiment of the disclosure.

In an embodiment of the disclosure, the electronic device may obtain a user image 410. The electronic device may provide content to a user and may obtain the user image 410 showing a posture of the user who has received the content through an external device.

Referring to FIG. 4, the user image 410 is described as an image including the user's entire body, but may be an image limited to the user's upper body. The technical concept of the disclosure is not limited thereto.

In an embodiment of the disclosure, a processor 1100 of the electronic device may obtain position data 425 about a joint of the user within the user image 410.

For example, the joint of the user includes the shoulders, waist, pelvis, knees, ankles, toes, elbows, wrists, and palms, and the joint of the user in the disclosure may include main parts of the face, such as, the eyes, nose, cheekbones, and mouth. However, a main point of a body part may be selected in various ways, and the joint of the user displayed according to the position data 425 of FIG. 4 is an example. The technical concept of the disclosure is not limited thereto.

In an embodiment of the disclosure, the electronic device may obtain the position data 425 by using a user behavior recognition module. The user behavior recognition module may be an artificial intelligence model that estimates a person's posture in a video or an image. The user behavior recognition module may be a model trained to estimate a person's posture based on the person's important body part. For example, the user behavior recognition module estimates a person's posture based on movement of the person's joint.

However, a method of obtaining the position data 425 does not limit the technical concept of the disclosure.

In an embodiment of the disclosure, the processor 1100 of the electronic device may obtain a feature point 435 related to the user's upper body from among a plurality of pieces of collected position data 425.

For example, the feature point 435 includes position coordinates of the user's body part including the hands, elbows, shoulders, waist, hip, neck, and face. The position of the feature point 435 is merely an example, and the technical concept of the disclosure is not limited thereto. For example, the feature point 435 is concentrated near a specific body part according to a method and purpose of estimating the user's posture, or may include a plurality of more detailed feature points.

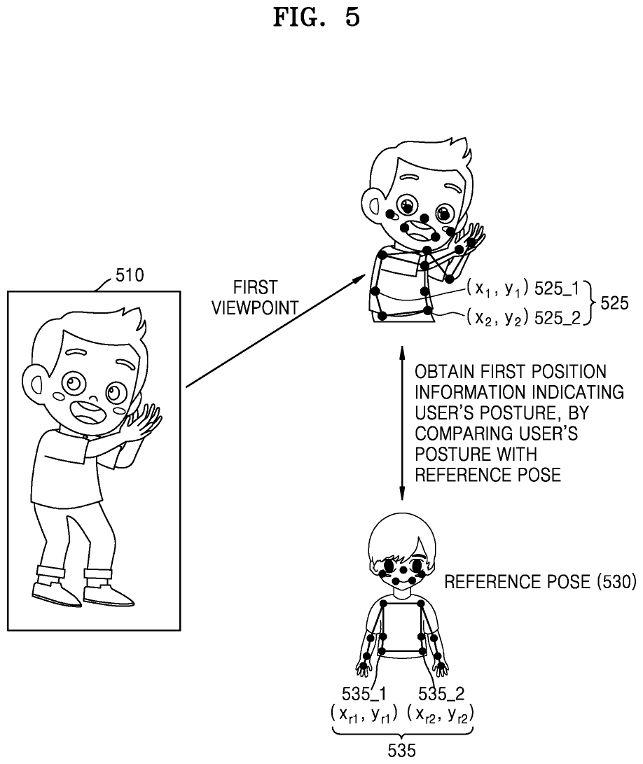

FIG. 5 is a diagram for describing a method, performed by an electronic device, of recognizing a user's posture by using a feature point, according to an embodiment of the disclosure.

Referring to FIG. 5, in an embodiment of the disclosure, the electronic device may obtain feature points 525 for recognizing a user posture from a user image 510. A method of obtaining the feature points 525 may be the same as described with reference to FIG. 4.

In an embodiment of the disclosure, the electronic device may preset a reference pose 530 for comparison with a response pose that appears when a user responds to provided content. The electronic device may store the preset reference pose 530 in a memory. The electronic device may store the position of a reference feature point 535 corresponding to the reference pose 530 in the memory.

The electronic device may obtain first position information by comparing the positions of the reference feature points 535 with the positions of the feature points 525 according to a posture of a user in the user image 510. The electronic device may obtain the first position information indicating the positions of the feature points 525 in the user image 510, based on the reference feature points 535.

For example, the feature points 525 includes a right pelvis feature point 525_1 and a left pelvis feature point 525_2. The reference feature points 535 may include a right pelvis reference feature point 535_1 and a left pelvis reference feature point 535_2. The electronic device may obtain the first position information about the left pelvis by calculating a difference between the positions of the left pelvis feature point 525_2 and the left pelvis reference feature point 535_2. In addition, the electronic device may obtain the first position information about the right pelvis by calculating a difference between the positions of the right pelvis feature point 525_1 and the right pelvis reference feature point 535_1.

The first position information may be information including a difference between the positions of the feature points 525 and the reference feature points 535 respectively corresponding to respective positions. The electronic device may detect the user's posture, based on how much each feature point 525 is changed from the reference feature points 535 and then positioned.

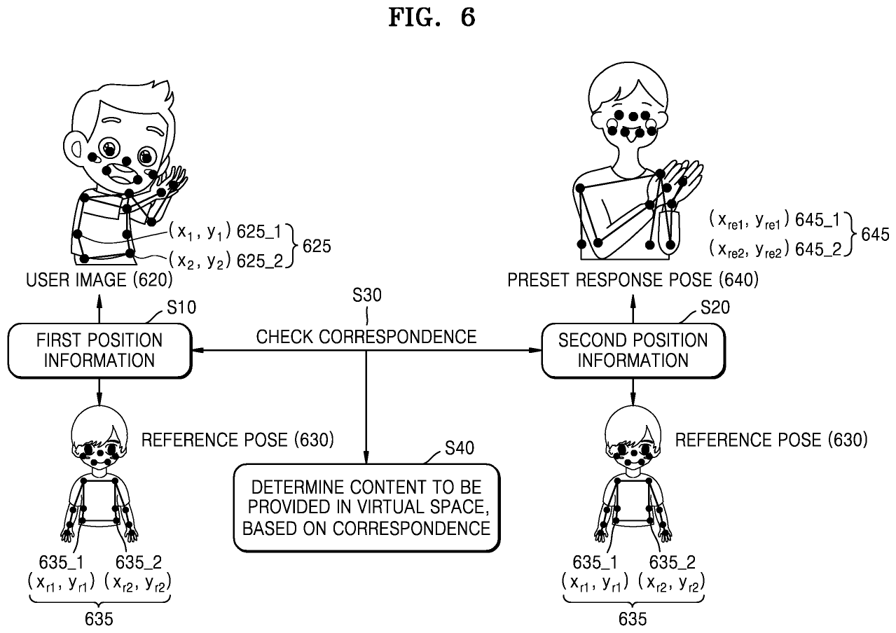

FIG. 6 is a diagram for describing a method, performed by an electronic device, of determining content according to whether a user's posture corresponds to a preset response pose, according to an embodiment of the disclosure.

For convenience of description, those redundant to the descriptions of FIGS. 4 and 5 are briefly described or are not provided.

Referring to FIG. 6, in an embodiment of the disclosure, the electronic device may obtain first position information indicating the positions of a plurality of feature points 625 in a user image 620 in operation S10.

The electronic device may preset a reference pose 630. The electronic device may obtain the positions of reference feature points 635 corresponding to the preset reference pose 630. The electronic device may obtain the first position information by comparing the positions of the reference feature points 635 with the positions of feature points 625 according to a posture of a user in the user image 620.

For example, the electronic device obtains (x1, y1), which are position coordinates of a right pelvis feature point 625_1, from the user image 620. However, for convenience of description, the position coordinates of the right pelvis feature point 625_1 are described as two-dimensional coordinates, but this does not limit the technical concept of the disclosure. For example, in the disclosure, position coordinates refer to two-dimensional coordinates or three-dimensional coordinates. The electronic device may obtain (xᵣ₁, yᵣ₁), which are position coordinates of a right pelvis reference feature point 635_1, from the reference pose 630.

The electronic device may obtain the first position information by comparing the position coordinates of the right pelvis feature point 625_1 with the position coordinates of the right pelvis reference feature point 635_1. In other words, the first position information obtained by comparing the position coordinates of the right pelvis feature point 625_1 with the position coordinates of the right pelvis reference feature point 635_1 may include information about movement of the user's right pelvis.

As another example, the electronic device obtains (x2, y2), which are position coordinates of a left pelvis feature point 625_2, from the user image 620. The electronic device may obtain (xᵣ₂, yᵣ₂), which are position coordinates of a left pelvis reference feature point 635_2, from the reference pose 630.

The electronic device may obtain the first position information by comparing the position coordinates of the left pelvis feature point 625_2 with the position coordinates of the left pelvis reference feature point 635_2. In other words, the first position information obtained by comparing the position coordinates of the left pelvis feature point 625_2 with the position coordinates of the left pelvis reference feature point 635_2 may include information about a posture of the user's left pelvis.

In an embodiment of the disclosure, the electronic device may obtain second position information about movement of response feature points 645 in a preset response pose 640 in operation S20.

The electronic device may preset the response pose 640 that appears when the user responds to provided content. The electronic device may obtain the positions of the response feature points 645 corresponding to the preset response pose 640. The electronic device may obtain the second position information by comparing the positions of the reference feature points 635 with the positions of the response feature points 645.

For example, the electronic device obtains (xᵣₑ₁, yᵣₑ₁), which are position coordinates of a right pelvis response feature point 645_1, from the preset response pose 640. However, for convenience of description, the position coordinates of the right pelvis response feature point 645_1 are described as two-dimensional coordinates, but this does not limit the technical concept of the disclosure. For example, in the disclosure, position coordinates refer to two-dimensional coordinates or three-dimensional coordinates. The electronic device may obtain the (xᵣ₁, yᵣ₁), which are the position coordinates of the right pelvis reference feature point 635_1, from the reference pose 630.

The electronic device may obtain the second position information by comparing the position coordinates of the right pelvis response feature point 645_1 with the position coordinates of the right pelvis reference feature point 635_1. In other words, the second position information obtained by comparing the position coordinates of the right pelvis response feature point 645_1 with the position coordinates of the right pelvis reference feature point 635_1 may include information about a posture of the user's right pelvis in a case where the user has assumed the preset response pose 640.

As another example, the electronic device obtains (xᵣₑ₂, yᵣₑ₂), which are position coordinates of a left pelvis response feature point 645_2, from the preset response pose 640. The electronic device may obtain the (xᵣ₂, yᵣ₂), which are the position coordinates of the left pelvis reference feature point 635_2, from the reference pose 630.

The electronic device may obtain the second position information by comparing the position coordinates of the left pelvis response feature point 645_2 with the position coordinates of the left pelvis reference feature point 635_2. In other words, the second position information obtained by comparing the position coordinates of the left pelvis response feature point 645_2 with the position coordinates of the left pelvis reference feature point 635_2 may include information about a posture of the user's left pelvis in a case where the user has assumed the preset response pose 640.

In an embodiment of the disclosure, the electronic device may obtain the first position information and the second position information and check whether the first position information and the second position information correspond to each other in operation S30. The electronic device may check how similar the posture of the user in the user image 620 is to the preset response pose 640, based on the reference pose 630. For example, when the first position information and the second position information correspond to each other, the electronic device determines that the user has taken a motion corresponding to the preset response pose 640.

In an embodiment of the disclosure, the electronic device may detect whether movement of the user in the user image 620 corresponds to the preset response pose 640 by using a response degree determination module. The response degree determination module may detect whether the movement of the user in the user image 620 corresponds to the preset response pose 640, by comparing the first position information with the second position information.

The response degree determination module may be a deep-learning model that classifies a posture of the user based on a change in the position of a feature point of the input user image 620 and outputs the degree of response according to the classified posture. For example, the response degree determination module includes a deep-learning model including at least one of an LSTM model or an attention model.

In an embodiment of the disclosure, the electronic device may obtain link information, which is information about connecting adjacent feature points, based on a feature point. For example, the electronic device obtains first link information, which is connection information between a first feature point and a second feature point in the user image 620. The first link information may include positional relationship information and weight value information between the first feature point and the second feature point. For example, the link information includes information about a distance and direction between two adjacent feature points, and the weight value information may indicate the degree of importance of two adjacent feature points in determining a person's posture.

For example, when a preset response pose is a hand-waving pose, link information between a feature point corresponding to the elbow and a feature point corresponding to the hand is important. In this case, weight value information between the feature point corresponding to the elbow and the feature point corresponding to the hand may be evaluated as being high.

As another example, when a preset response pose is a hand-waving pose, link information between a feature point corresponding to the left waist and a feature point corresponding to the right waist is relatively less important. In this case, weight value information between the feature point corresponding to the left waist and the feature point corresponding to the right waist may be evaluated as being low.

Likewise, the electronic device may obtain second link information based on the preset response pose 640. A method of obtaining the second link information is similar to a method of obtaining the first link information and thus is briefly described.

For example, the electronic device obtains the second link information, which is connection information between a first response feature point and a second response feature point in the preset response pose 640. The second link information may include positional relationship information and weight value information between the first response feature point and the second response feature point.

In an embodiment of the disclosure, the electronic device may obtain the second link information indicating a relationship between adjacent feature points, by comparing a relationship between adjacent feature points included in the preset response pose 640 and the reference pose 630. The electronic device may obtain the second link information by comparing link information that may be obtained from adjacent reference feature points 635 in the reference pose 630 with link information that may be obtained from adjacent response feature points 645 in the preset response pose 640.

The second link information may be information about a relationship between adjacent feature points that may be obtained by comparing the preset response pose 640 with the reference pose 630. The second link information may be information indicating a relationship between adjacent feature points corresponding to the preset response pose 640, based on adjacent feature points in the reference pose 630. The electronic device may check whether the user's posture corresponds to the preset response pose 640, by comparing the second link information with the first link information.

In an embodiment of the disclosure, the electronic device may determine content to be provided in a virtual space, based on the correspondence checked in operation S30 in operation S40. Descriptions of operation S40 are redundant to the descriptions of operation S240 of FIG. 2 and thus are not provided.

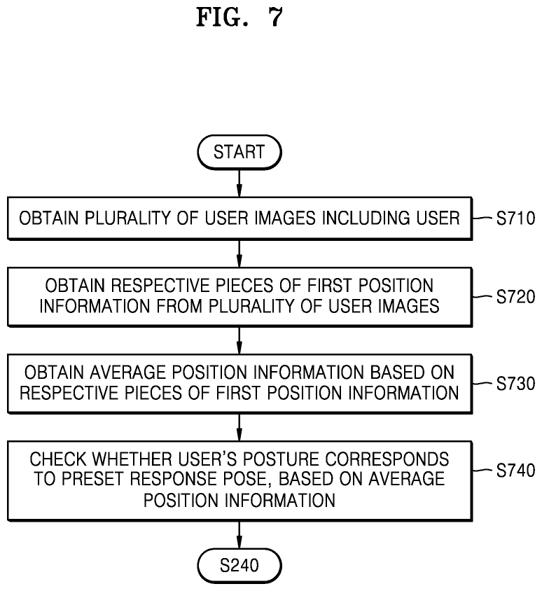

FIG. 7 is a flowchart for describing an operation in which an electronic device detects a user's posture, based on a feature point, according to an embodiment of the disclosure.

Referring to FIG. 7, in operation S710, the electronic device may obtain a plurality of user images including a user.

In an embodiment of the disclosure, the electronic device may obtain a plurality of user images showing a posture of a single user who has received content. The plurality of user images may be captured images of behaviors of the single user.

For example, the plurality of user images are images of the single user captured via a plurality of cameras. When the plurality of cameras are configured in various arrangements, the plurality of user images may be images of a posture of the single user captured from various viewpoints. As another example, when a plurality of cameras with different viewing angles are used, the positions corresponding to the user's feature points in the plurality of user images is different.

In operation S720, the electronic device may obtain respective pieces of first position information from the plurality of user images.

Descriptions of operation S720 are redundant to the descriptions of operation S220 of FIG. 2 and thus are briefly provided.

In an embodiment of the disclosure, a user image may include a plurality of images including a same user. The electronic device may obtain pieces of first position information, which indicate the positions of a plurality of feature points indicating a specific part of the user's body, respectively from the plurality of user images.

Even when the plurality of user images are obtained by capturing images of a same user, the respective pieces of first position information corresponding to the plurality of user images may not match. For example, in the plurality of user images, the positions of feature points are measured differently depending on the position of a camera, the type of the camera, noise, and the like.

In an embodiment of the disclosure, the electronic device may obtain position data about a joint of the user in each of the plurality of user images, and may extract feature points related to the user's upper body. The electronic device may obtain a plurality of pieces of first position information about the positions of feature points in the plurality of user images.

In operation S730, the electronic device may obtain average position information based on the respective pieces of first position information.

For example, the electronic device obtains a plurality of feature points corresponding to the left pelvis from the plurality of user images. The electronic device may obtain a plurality of pieces of first position information about the left pelvis by comparing the plurality of feature points with a reference feature point corresponding to the left pelvis. The electronic device may obtain average position information based on the plurality of pieces of first position information.

In an embodiment of the disclosure, the plurality of pieces of first position information may include a plurality of position values indicating the positions of a plurality of feature points. The average position information may include an average position value indicating an average position of the plurality of feature points, the average position value being obtained by averaging the plurality of position values.

Furthermore, the electronic device may obtain a plurality of pieces of first position information corresponding to each body part, and may obtain average position information about each body part by averaging position values corresponding to the plurality of pieces of first position information for each body part.

In operation S740, the electronic device may check whether the user's posture corresponds to a preset response pose, based on the average position information.

In an embodiment of the disclosure, the electronic device may check whether the user's posture corresponds to the preset response pose by comparing second position information with the average position information. The second position information is information about the position of a feature point corresponding to the preset response pose. In an embodiment of the disclosure, the electronic device may check whether a posture of the user in a user image corresponds to the preset response pose, by comparing the average position information with the second position information. For example, as the similarity between average position information and the second position information increases, the electronic device detects that the user has assumed a pose corresponding to the response pose.

In an embodiment of the disclosure, the electronic device may detect that the user has assumed a pose corresponding to the response pose, by using a response degree determination module. The electronic device may obtain the degree of response that is the degree of response of the user to content, by using the response degree determination module. The response degree determination module may include a deep learning model that receives an input of an image to detect and classify a posture of a person and output the degree of response according to the classified posture.

FIG. 8 is a flowchart for describing an operation in which an electronic device provides content in a virtual space, according to an embodiment of the disclosure.

Referring to FIG. 8, in operation S810, the electronic device may obtain a user image including a user. Descriptions of operation S810 are redundant to the descriptions of operation S210 and thus are not provided.

In operation S820, the electronic device may obtain first position information indicating the positions of a plurality of feature points indicating a specific part of the user's body from the user image. Descriptions of operation S820 are redundant to the descriptions of operation S220 and thus are not provided.

In operation S830, the electronic device may check whether a posture of the user included in the user image corresponds to a preset pose, based on the first position information. Descriptions of operation S830 are redundant to the descriptions of operation S230 and thus are briefly provided.

In an embodiment of the disclosure, the preset pose may include a response pose and a standby pose.

A preset response pose may include a clapping pose, a cheering pose, an arm-opening pose, a dancing pose, and a one-hand-raising pose, but the type of response pose is merely an example and does not limit the technical concept of the disclosure. For example, the response pose also includes a pose where the hand is placed at a chest level to raise the hand as a preparation posture for raising one hand.

A preset standby pose may be a pose set for a case where the user does not respond to content. For example, the preset standby pose includes a posture of standing upright with both arms pointing downward. As another example, the preset standby pose is set to be the same as a reference pose.

When the user's posture corresponds to the preset response pose in operation S840, the electronic device may obtain a first response degree in correspondence to the user's posture in operation S850.

In an embodiment of the disclosure, depending on the degree of response of the user, the degree of response may include the first response degree indicating a high level of degree of response and a second response degree indicating a low level of degree of response.

For convenience of description, the degree of response are shown to have, for example, two levels, and does not limit the technical concept of the disclosure. For example, the degree of response is classified into five levels or may be calculated as a percentage.

For example, the preset response pose is a clapping pose. The electronic device may check that the user's posture corresponds to a clapping pose, based on the user image. The electronic device may detect the user's clapping posture and may obtain the first response degree in correspondence to the clapping posture. The electronic device may check that the user in the user image has a high degree of response to provided content, by obtaining the first response degree.

When the user's posture does not correspond to the preset response pose, the electronic device may check whether the user's posture corresponds to the preset standby pose. When the user's posture corresponds to the preset standby pose in operation S845, the electronic device may obtain the second response degree in correspondence to the user's posture in operation S860.

For example, the electronic device checks whether the user's posture corresponds to the standby pose, based on the user image. The electronic device may detect the user's standby pose and may obtain the second response degree in correspondence to the standby pose. The electronic device may check that the user in the user image has a low degree of response to provided content, by obtaining the second response degree.

In operation S870, the electronic device may provide content combined with the user image, based on the degree of response.

In an embodiment of the disclosure, the electronic device may obtain the degree of response corresponding to the obtained user image. The obtained degree of response may include at least one of the first response degree obtained in operation S850 or the second response degree obtained in operation S860.

In an embodiment of the disclosure, the electronic device may provide content to the user via an external device. The electronic device may combine the user image with the content, based on the degree of response.

For example, the electronic device obtains a first user image. The first user image may be an image of a first user assuming various postures while watching content. The electronic device may detect that the first user assumes a pose corresponding to the preset response pose from the first user image. The electronic device may obtain the first response degree with respect to the first user image, in correspondence to the first user's posture. In other words, the first user image may be determined to be an image with a high degree of response.

The electronic device may combine the first user image having the first response degree with content and provide the combined content to a user. The electronic device may provide the combined content to a plurality of users including the first user.

As another example, the electronic device obtains a second user image. The second user image may be an image of a second user showing various behaviors while watching content. The electronic device may detect that the second user assumes a pose corresponding to the preset standby pose from the second user image. The electronic device may obtain the second response degree with respect to the second user image, in correspondence to the second user's posture. In other words, the second user image may be determined to be an image with a low degree of response.

The electronic device may not combine the second user image having the second response degree with content.

In an embodiment of the disclosure, the electronic device may obtain a plurality of user images showing postures of a plurality of users who have received content. The electronic device may provide content combined with a user image, based on the plurality of user images.

For example, the electronic device obtains the first user image and the second user image. For convenience of description, descriptions are made based on two distinct user images, but the number of user images does not limit the technical concept of the disclosure.

The first user image may be an image of the first user showing various behaviors while watching content. The electronic device may detect that the first user assumes a pose corresponding to the preset response pose from the first user image. The electronic device may obtain the first response degree with respect to the first user image, in correspondence to the first user's posture. In other words, the first user image may be determined to be an image with a high degree of response.

The second user image may be an image of a second user showing various behaviors while watching content. The electronic device may detect that the second user assumes a pose corresponding to the preset standby pose from the second user image. The electronic device may obtain the second response degree with respect to the second user image, in correspondence to the second user's posture. In other words, the second user image may be determined to be an image with a low degree of response.

The electronic device may combine the first user image having the first response degree with content and may not combine the second user image having the second response degree with the content. The electronic device may provide the content combined with the first user image to the user. The electronic device may provide the combined content to a plurality of users including at least one of the first user or the second user.

FIG. 9 is a flowchart for describing an operation in which an electronic device determines the degree of response of a user, according to an embodiment of the disclosure. For reference, after operation S240 of FIG. 2 is performed, operation S250 may be performed, including operation S910 to operation S930.

Referring to FIG. 9, in operation S910, when the user's posture corresponds to the preset response pose, the electronic device may obtain at least one of pose variance information, pose count information or pose duration information, which are related to a pose assumed by the user.

In an embodiment of the disclosure, the electronic device may obtain at least one of pose variance information, pose count information or pose duration information, which are related to a pose assumed by the user, based on whether the user's posture corresponds to the preset response pose. When it is determined that the user's posture corresponds to the preset response pose, the electronic device may obtain at least one of pose variance information, pose count information, or pose duration information.

The pose variance information may indicate the size of a motion that may be measured as the user assumes a pose corresponding to the preset response pose. For example, the preset response pose is a hand-waving pose. In the hand-waving pose, the size of a motion may vary depending on movement of the hand.

As a specific example, in the case of extending the arm in a straight line and waving the hand, the motion is large. In contrast, in the case of waving the hand with the arm slightly bent, the motion may be small. As another example, in a case where the user waves their hand, when the rotation angle at which the user waves their hand is large, the motion is large. In contrast, when the rotation angle at which the user waves their hand is small, the motion may be small.

The pose variance information may be calculated based on position coordinates of a feature point. For example, in the case of a hand-waving pose, movement of the hand is important information. The electronic device may obtain a variance of a feature point, based on position coordinates of the feature point corresponding to the user's hand. Based on the variance of the feature point, the electronic device may calculate the pose variance information.

The pose count information may indicate the number of times it is determined that the user's posture corresponds to the preset response pose. For example, the preset response pose is a hand-waving pose. When the user waves their hand, assumes a standby pose, and then waves their hand again, the pose count information may indicate two times.

The pose duration information may indicate the duration during which it is determined that the user's posture corresponds to the preset response pose. For example, the preset response pose is a hand-waving pose. When the user waves their hand for 10 seconds, the pose duration information may indicate 10 seconds.

In operation S920, the electronic device may determine the degree of response related to the degree of response of the user to content, based on the at least one of the pose variance information, the pose count information, or the pose duration information.

In an embodiment of the disclosure, the electronic device may determine the degree of response, based on the at least one of the pose variance information, the pose count information, or the pose duration information. Depending on the degree of response of the user, the degree of response may include a first response degree indicating a high level of degree of response and a second response degree indicating a low level of degree of response.

For example, the pose variance information indicates the size of a motion assumed by the user. A larger value according to the pose variance information may mean that the user assumes a pose with a larger motion. When a value according to the pose variance information is large, the electronic device may match the first response degree to the user image. In contrast, when a value according to the pose variance information is small, the electronic device may match the second response degree to the user image.

As another example, the pose count information indicates the number of times the user assumes a pose. A larger value according to the pose count information may mean that the number of times the user assumes a pose increases. When a value according to the pose count information is large, the electronic device may match the first response degree to the user image. In contrast, when a value according to the pose count information is small, the electronic device may match the second response degree to the user image.

As another example, the pose duration information indicates the duration during which the user assumes a pose. A larger value according to the pose duration information may mean that the user maintains a pose for a longer period of time. When a value according to the pose duration information is large, the electronic device may match the first response degree to the user image. When a value according to the pose duration information is small, the electronic device may match the second response degree to the user image.

In operation S930, the electronic device may provide content combined with the user image, based on the degree of response.

In an embodiment of the disclosure, the electronic device may obtain a first user image corresponding to a first response degree indicating a high degree of response and a second user image corresponding to a second response degree indicating a low degree of response.

The electronic device may combine the first user image corresponding to the first response degree with content and may not combine the second user image corresponding to the second response degree with the content. The electronic device may provide the combined content to the user.

However, the user image to be combined with the content may vary depending on the situation, purpose, etc., and in some cases, the second user image corresponding to the second response degree indicating a low degree of response may be combined with the content.

In an embodiment of the disclosure, the electronic device may obtain a first user image to a tenth user image. For convenience of description, descriptions are made based on 10 distinct user images, but the number of user images does not limit the technical concept of the disclosure. In addition, in this example, it is described that the degree of response is divided into stages and include a first response degree indicating the highest degree of response to a tenth response degree indicating the lowest degree of response.

The first user image may be an image of a first user showing various behaviors while watching content. The electronic device may detect that the first user assumes a pose corresponding to the preset response pose from the first user image. The electronic device may obtain the first response degree with respect to the first user image, in correspondence to the first user's posture. In other words, the first user image may be determined to be an image with the highest degree of response.

The tenth user image may be an image of a tenth user showing various behaviors while watching content. The electronic device may detect that the tenth user assumes a pose corresponding to the preset standby pose from the tenth user image. The electronic device may obtain the tenth response degree with respect to the tenth user image, in correspondence to the tenth user's posture. In other words, the tenth user image may be determined to be an image with the lowest degree of response.

The second user image to the ninth user image may be images of second user to ninth user showing various behaviors while watching content. The electronic device may obtain the second response degree to the ninth response degree respectively with respect to the second user image to the ninth user image, in correspondence to the second user's posture to the ninth user's posture. In other words, the second user image may be determined to be an image with the second highest degree of response, the third user image may be determined to be an image with the third highest degree of response, and the ninth user image may be determined to be an image with the ninth highest degree of response and the second lowest degree of response.

In an embodiment of the disclosure, the electronic device may select a user image to be combined with content according to the type of content, the purpose and intention of content production, etc. The electronic device may select some of the first user image to the tenth user image. For example, the electronic device selects the first user image to the fourth user image in decreasing order of degree of response. The electronic device may combine the selected first user image to fourth user image with the content. The electronic device may not combine the unselected fifth user image to tenth user image with the content. The electronic device may provide the content combined with the first user image to the fourth user image to the user. The electronic device may provide the combined content to a plurality of users including at least one of the first user to the tenth user.

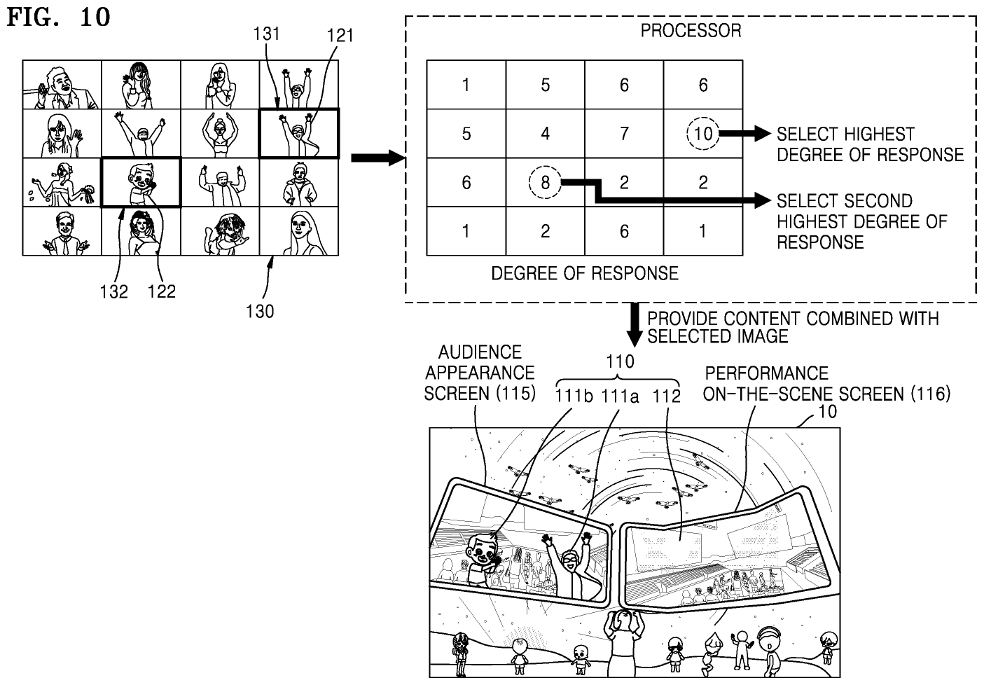

FIG. 10 is a diagram for describing a method, performed by an electronic device, of providing content in a virtual space, according to an embodiment of the disclosure.

Referring to FIG. 10, an electronic device according to an embodiment of the disclosure may provide the content 110 in the virtual space 10. The electronic device may provide the content 110 to a user. In an embodiment, the electronic device may obtain a plurality of user images 130 showing postures of a plurality of users who have received the content 110.

The content 110 provided by the electronic device according to an embodiment of the disclosure may be combined with the plurality of user images 130. Users 121 and 122 may react to the content 110 through avatars and simultaneously share the users' own reactions with other users through the content 110 combined with the plurality of user images 130.

In an embodiment of the disclosure, the electronic device may determine the degree of response according to the users' postures, based on the received plurality of user images 130. A method of determining the degree of response is as described with reference to FIGS. 4 to 6, 8, and 9, and thus, description thereof is not provided.

In an embodiment of the disclosure, the electronic device may determine the degree of response, in correspondence to each of the plurality of user images 130. As shown, a processor of the electronic device may receive inputs of the plurality of user images 130 and determine the degree of response corresponding to each of the plurality of user images 130. Based on the determined degrees of response, the processor may obtain a ranking of the degrees of response with respect to the plurality of user images 130.

For example, the processor obtains a plurality of degrees of response respectively corresponding to the plurality of user images 130. The processor may determine that the first user image 131 has the highest degree of response among the plurality of user images 130, and may determine that a second user image 132 has the second highest degree of response among the plurality of user images 130.

In an embodiment of the disclosure, the processor may select the first user image 131 determined to have the highest degree of response and the second user image 132 determined to have the second highest degree of response. The processor may combine the first user image 131 and the second user image 132 with content. The electronic device according to an embodiment of the disclosure may provide the content combined with the first user image 131 and the second user image 132 to the user.

As shown, the electronic device may provide the content 110 through the first region 115 and the second region 116 in a virtual space. The first region 115 may refer to an audience appearance screen, and the second region 116 may refer to a performance on-the-scene screen. The electronic device may provide the live performance content 112 within the performance on-the-scene screen. The electronic device may display both the first user image 131 as first audience appearance content 111a and the second user image 132 as second audience appearance content 111b within the audience appearance screen.

However, the number of user images that may be combined with content does not limit the technical concept of the disclosure. In addition, criteria for selecting a user image to be combined with content do not limit the technical concept of the disclosure. For example, in the disclosure, it is described that a user image with a high degree of response is combined with content, but according to the purpose of the content, a user image with a low degree of response is combined with the content.

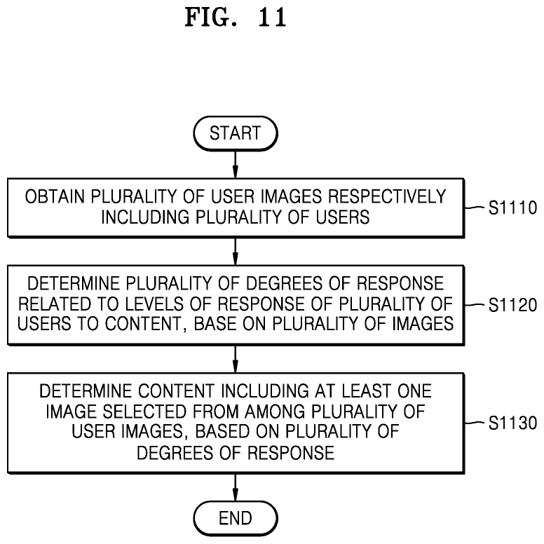

FIG. 11 is a flowchart for describing an operation in which an electronic device determines content based on the degree of response of a user, according to an embodiment of the disclosure. For convenience of description, those redundant to the descriptions of FIG. 2 are briefly described or are not provided.

Referring to FIG. 11, in operation S1110, the electronic device may obtain a plurality of user images respectively including a plurality of users.

In an embodiment of the disclosure, the electronic device may provide content to the plurality of users by using a communication interface. The electronic device may obtain the plurality of user images showing postures of the plurality of users from the plurality of users who have received the content.

In operation S1120, the electronic device may determine a plurality of degrees of response related to levels of response of the plurality of users to the content, based on the plurality of user images.

For reference, descriptions of operation S1120 are redundant to the descriptions of operation S850 to operation S860 of FIG. 8 and thus are briefly provided.

In an embodiment of the disclosure, the electronic device may determine a plurality of degrees of response, in correspondence to the obtained plurality of user images. The electronic device may obtain a feature point related to a user's upper body with respect to each user image. The electronic device may obtain first position information about the position of a feature with respect to each user image. The electronic device may check whether each user's posture corresponds to a preset response pose, by comparing second position information about the position of a feature point corresponding to the preset response pose with the first position information, with respect to each user image. The electronic device may determine the degree of response related to the degree of response of each user to the content, based on whether each user's posture corresponds to the preset response pose, with respect to each user image.

In operation S1130, the electronic device may determine content including at least one image selected from among the plurality of user images, based on the plurality of degrees of response.

In an embodiment of the disclosure, certain criteria for selecting at least one of the plurality of degrees of response may vary depending on the purpose and intention of the content.

For example, the electronic device provides content that focuses on displaying a user with the highest degree of response. In this case, the electronic device may select the highest degree of response among the plurality of degrees of response. The electronic device may obtain a user image corresponding to the highest degree of response. The electronic device may combine the selected at least one user image with content to provide the combined content to a user.

As another example, the electronic device provides content that displays a plurality of users with high degrees of response. In this case, the electronic device may classify the degrees of response that are greater than a threshold among the plurality of degrees of response. The electronic device may obtain user images corresponding to the classified degrees of response. The electronic device may combine the obtained at least one user image with content to provide the combined content to a user.

As another example, the electronic device provides content that displays a user with a low degree of response. In this case, the electronic device may select the lowest degree of response among the plurality of degrees of response. The electronic device may obtain a user image corresponding to the lowest degree of response. The electronic device may combine the selected at least one user image with content to provide the combined content to a user.

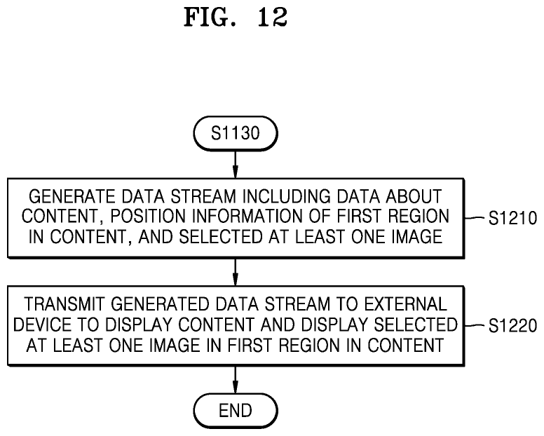

FIG. 12 is a flowchart for describing an operation in which an electronic device transmits a data stream to display content through an external device, according to an embodiment of the disclosure. For reference, after operation S1130 of FIG. 11 is performed, operation S1210 may be performed.

Referring to FIG. 12, in operation S1210, the electronic device may generate a data stream including data about the content, position information of a first region in the content, and the selected at least one image.

However, a configuration of the data stream does not limit the technical concept of the disclosure, and may include information for the electronic device to display the selected at least one image within the first region in the content through an external device. The electronic device may generate a data stream including more pieces of data, and for example, the electronic device further includes information about the time at which the selected at least one image is displayed.

In operation S1220, the electronic device may transmit the generated data stream to an external device.

In an embodiment of the disclosure, the electronic device may generate a data stream, and the generated data stream may be received by an external device. The electronic device may transmit the data stream to the external device to display the content and display the selected at least one image in the first region in the content.

Referring further to FIG. 10 together with FIG. 12, the electronic device may provide the content 110 through the first region 115 and the second region 116 in a virtual space. The first region 115 may refer to an audience appearance screen shown in FIG. 10, and the second region 116 may refer to a performance on-the-scene screen shown in FIG. 10. The electronic device may transmit the generated data stream to the external device to display the content 110 through the first region 115 and the second region 116 in a virtual space through the external device.

The content 110 may include the live performance content 112 and the audience appearance content 111. The electronic device may provide content to be provided to a user as the live performance content 112 and may provide at least one user image as the audience appearance content 111. The content 110 may be a combination of the live performance content 112 to be provided to a user and at least one user image as the audience appearance content 111.

In an embodiment of the disclosure, as shown in FIG. 10, the first and second user images 131 and 132 combined with the live performance content 112 may be included in the first region (audience appearance screen). In an embodiment of the disclosure, as shown in FIG. 1, one user image 131 combined with the live performance content 112 may be included in the first region (audience appearance screen).

The electronic device may display the first and second user images 131 and 132 included in the live performance content 112 and the first region (audience appearance screen) through the external device, by transmitting the generated data stream to the external device. In addition, the electronic device may display one user image 131 included in the live performance content 112 and the first region (audience appearance screen) through the external device, by transmitting the generated data stream to the external device.

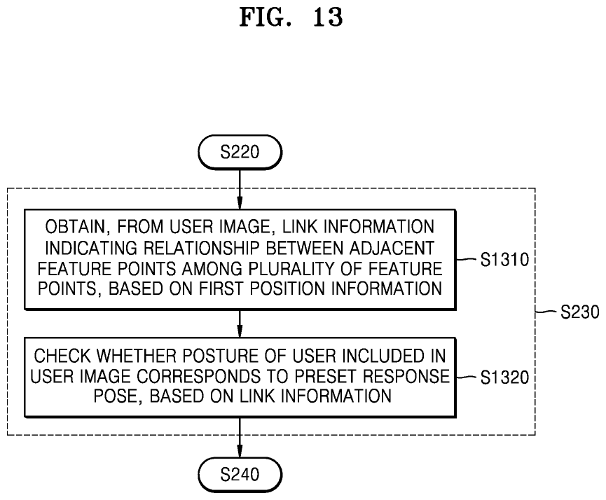

FIG. 13 is a diagram for describing a method, performed by an electronic device, of recognizing a user's posture by using link information, according to an embodiment of the disclosure. For reference, operation S230 of FIG. 2 may include operation S1310 and operation S1320.

For convenience of description, those redundant to the descriptions of FIG. 6 are briefly described.

Referring to FIG. 13, in operation S1310, the electronic device may obtain, from the user image, link information indicating a relationship between adjacent feature points among the plurality of feature points, based on the first position information.

In an embodiment of the disclosure, the electronic device may obtain link information, which is information about connecting adjacent feature points, based on a feature point. The link information may indicate a relationship between two adjacent feature points among a plurality of feature points corresponding to a person's posture. The link information may include positional relationship information and weight value information between two adjacent feature points. For example, the link information includes information about a distance and direction between two adjacent feature points, and the weight value information may indicate the degree of importance of two adjacent feature points in determining a person's posture.

In an embodiment of the disclosure, the link information may include information about a distance and direction between two adjacent feature points, and may be calculated based on position information indicating the positions of a plurality of feature points.

In an embodiment of the disclosure, the link information may include weight value information indicating the degree of importance about a relationship between two adjacent feature points.

For example, when a preset response pose is a hand-waving pose, link information between a feature point corresponding to the elbow and a feature point corresponding to the hand is important. In this case, weight value information between the feature point corresponding to the elbow and the feature point corresponding to the hand may be evaluated as being high.

As another example, when a preset response pose is a hand-waving pose, link information between a feature point corresponding to the left waist and a feature point corresponding to the right waist is relatively less important. In this case, weight value information between the feature point corresponding to the left waist and the feature point corresponding to the right waist may be evaluated as being low.

In operation S1320, the electronic device may check whether the posture of the user included in the user image corresponds to the preset response pose, based on the link information.

In an embodiment of the disclosure, the electronic device may check whether the posture of the user corresponds to the preset response pose, by comparing user link information with response link information. The user link information may be information indicating a relationship between two adjacent feature points among the plurality of feature points corresponding to the posture of the user in the user image. The response link information may be information indicating a relationship between two adjacent feature points among a plurality of feature points corresponding to the preset response pose.

For example, the user link information includes information indicating a relationship between a first feature point and a second feature point respectively corresponding to the adjacent elbow and hand of the user in the user image. The response link information may include information indicating a first feature point and a second feature point corresponding to the adjacent elbow and hand, respectively, from the preset response pose. The electronic device may compare the preset response pose with the posture of the user in the user image, by comparing the user link information with the response link information. The electronic device may compare a distance and direction between the elbow and the hand in the preset response pose with a distance and direction between the elbow and the hand of the user in the user image.

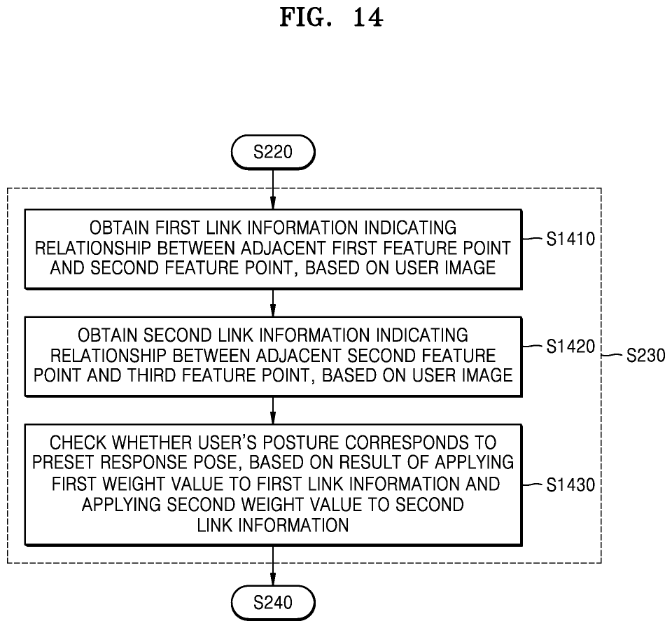

FIG. 14 is a diagram for describing a method, performed by an electronic device, of recognizing a user's posture by using link information, according to an embodiment of the disclosure. For reference, operation S230 of FIG. 2 may include operation S1410 to operation S1430.

Referring to FIG. 14, in operation S1410, the electronic device may obtain first link information indicating a relationship between an adjacent first feature point and second feature point, based on the user image. In operation S1420, the electronic device may obtain second link information indicating a relationship between an adjacent second feature point and third feature point, based on the user image.

A method of obtaining the first link information and the second link information is as described with reference to FIG. 13, and thus, description thereof is not provided.

In operation S1430, the electronic device may check whether the user's posture corresponds to the preset response pose, based on a result of applying a first weight value to the first link information and applying a second weight value to the second link information.

In an embodiment of the disclosure, among relationships between two adjacent feature points corresponding to a person's posture, a specific relationship may have a significant impact on detecting whether the user's posture corresponds to the preset response pose.

For example, when a preset response pose is a hand-waving pose, link information between a feature point corresponding to the elbow and a feature point corresponding to the hand is important. In this case, weight value information between the feature point corresponding to the elbow and the feature point corresponding to the hand may be evaluated as being high.

As another example, when a preset response pose is a hand-waving pose, link information between a feature point corresponding to the left waist and a feature point corresponding to the right waist is relatively less important. In this case, weight value information between the feature point corresponding to the left waist and the feature point corresponding to the right waist may be evaluated as being low.

Therefore, when the preset response pose is a hand-waving pose, a first weight value with a high value may be applied to a relationship between the feature points corresponding to the elbow and the hand, and a second weight value with a low value may be applied to a relationship between the left waist and the right waist.

The electronic device may apply the first weight value to the first link information indicating the relationship between the feature points corresponding to the elbow and the hand, and may apply the second weight value to the second link information indicating the relationship between the feature points corresponding to the left waist and the right waist. In this regard, the meaning of the application may include, for example, the multiplication of numbers, but a computation method does not limit the technical concept of the disclosure.

The electronic device may check whether the user's posture corresponds to a hand-waving pose, based on a result of applying the first weight value to the first link information and applying the second weight value to the second link information. In addition, the electronic device may calculate an appropriate weight value for each pieces of link information, according to the preset response pose.

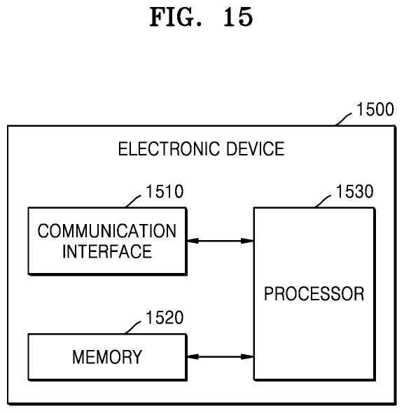

FIG. 15 is a block diagram showing a configuration of an electronic device according to an embodiment of the disclosure.

In an embodiment of the disclosure, an electronic device 1500 may include a communication interface 1510, a memory 1520, and a processor 1530.

The communication interface 1510 may include a communication circuit. The communication interface 1510 may include a communication circuit that may perform data communication between the electronic device 1500 and other devices, by using at least one of data communication schemes including, for example, wired local area network (LAN), wireless LAN, wireless-fidelity (Wi-Fi), Bluetooth, ZigBee, Wi-Fi Direct (WFD), Infrared Data Association (IrDA), Bluetooth Low Energy (BLE), near field communication (NFC), Wireless Broadband Internet (Wibro), World Interoperability for Microwave Access (WiMAX), Shared Wireless Access Protocol (SWAP), Wireless Gigabit Alliance (WiGig), and radio frequency (RF) communication.

The communication interface 1510 may transmit/receive data for performing an operation of the electronic device 1500 to/from an external electronic device. For example, the electronic device 1500 provides content to an external device through the communication interface 1510, and may receive an image of a user captured by a camera from the external device.

The memory 1520 may store instructions, a data structure, and program code, which are readable by the processor 1530. The memory 1520 may include at least one memory 1520. In the disclosed embodiments of the disclosure, operations performed by the processor 1530 may be implemented by executing instructions or codes of a program stored in the memory 1520.

The memory 1520 may include a non-volatile memory, such as read-only memory (ROM) (e.g., programmable read-only memory (PROM)), erasable programmable read-only memory (EPROM), electrically erasable programmable read-only memory (EEPROM), flash memory (e.g., memory card, solid-state drive (SSD)), and analog recording type (e.g., hard disk drive (HDD), magnetic tape, optical disk), and a volatile memory, such as random-access memory (RAM) (e.g., dynamic random-access memory (DRAM)) and static random-access memory (SRAM).

The processor 1530 may control overall operations of the electronic device 1500. For example, the processor 1530 controls overall operations for the electronic device 1500 to provide content in a virtual space, by executing one or more instructions of a program stored in the memory 1520. The processor 1530 may include at least one processor 1530.

The processor 1530 may perform operations of the above-described embodiment of the disclosure. For example, the processor 1530 obtains an image including a user, obtain first position information indicating the positions of a plurality of feature points indicating a specific part of the user's body from the image, check whether a posture of the user included in the image corresponds to a preset response pose, based on the first position information, and determine content to be provided in a virtual space, based on whether the user's posture corresponds to the preset response pose. Specific operations of the processor 1530 have been described, and thus, redundant descriptions are not provided for brevity.

The at least one processor 1530 may include at least one of a central processing unit (CPU), a graphics processing unit (GPU), an accelerated processing unit (APU), a many integrated core (MIC), a digital signal processor (DSP), or a neural processing unit (NPU). The at least one processor 1530 may be implemented in the form of an integrated system-on-chip (SoC) including at least one electronic component. Each of the at least one processor 1530 may be implemented as separated hardware (H/W).

When a method according to an embodiment of the disclosure includes a plurality of operations, the plurality of operations may be performed by one processor 1530 or may be performed by a plurality of processors 1530. For example, when a first operation, a second operation, and a third operation are performed by a method according to an embodiment of the disclosure, all of the first operation, the second operation, and the third operation are performed by a first processor, or the first operation and the second operation are performed by the first processor (e.g., general-purpose processor) and the third operation may be performed by a second processor (e.g., artificial intelligence-dedicated processor). In this regard, an example of the second processor may be an artificial intelligence-dedicated processor, and the artificial intelligence-dedicated processor may perform computation for training/interference of an artificial intelligence model. However, embodiments of the disclosure are not limited thereto.

The at least one processor 1530 according to the disclosure may be implemented as a single-core processor or a multi-core processor.

When a method according to an embodiment of the disclosure includes a plurality of operations, the plurality of operations may be performed by one core or may be performed by a plurality of cores included in the at least one processor 1530.

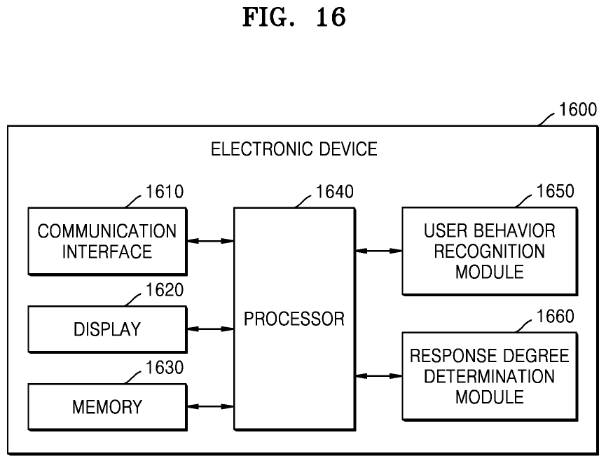

FIG. 16 is a detailed block diagram showing a configuration of an electronic device according to an embodiment of the disclosure.

Referring to FIG. 16, in an embodiment of the disclosure, an electronic device 1600 may include a communication interface 1610, a display 1620, a memory 1630, a processor 1640, a user behavior recognition module 1650, and a response degree determination module 1660.

The communication interface 1610, the memory 1630, and the processor 1640 of FIG. 16 respectively correspond to the communication interface 1510, the memory 1520, and the processor 1530 of FIG. 15, and thus, redundant descriptions are not provided.

The display 1620 may output an image signal on a screen of the electronic device 1600 under control by the processor 1640. For example, the electronic device 1600 outputs media content representing a virtual space through the display 1620.

The user behavior recognition module 1650 perform a processing operation on a user image received by the electronic device 1600. The user behavior recognition module 1650 may obtain position data about a joint of a user in the user image. For example, the user behavior recognition module 1650 sets the position of a joint of a person and may receive an input of a user image to detect movement of a joint according to movement of a user in the user image.

The response degree determination module 1660 may determine the degree of response by using the position data about the user's joint, the position data being obtained by the user behavior recognition module 1650. The response degree determination module 1660 may compare the position data about the user' joint with position data about a joint in a reference pose. The response degree determination module 1660 may obtain first position information about the user's joint according to a result of the comparison. Likewise, the response degree determination module 1660 may obtain second position information by comparing position data about a joint in a preset response pose with the position data about the joint in the reference pose. The response degree determination module 1660 may detect whether the user in the user image takes a motion corresponding to the preset response pose, by comparing the first position information with the second position information.

In an embodiment of the disclosure, the response degree determination module 1660 may use link information, which is information about connecting adjacent feature points, based on a feature point.

The link information may include positional relationship information and weight value information between adjacent feature points. For example, the positional relationship information includes information about a distance and direction between two adjacent feature points, and the weight value information may indicate the degree of importance of two adjacent feature points in determining a person's posture.

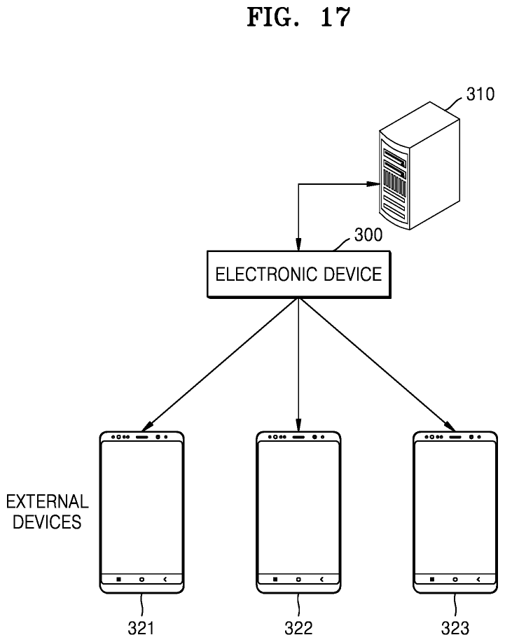

FIG. 17 is a diagram showing a system that provides a virtual space, according to an embodiment of the disclosure.

Referring to FIG. 17, a system according to an embodiment of the disclosure may include the electronic device 300, the server 310, and external devices 321, 322, and 323. The external devices may include at least one of external devices.

The external devices 321, 322, and 323 according to an embodiment of the disclosure may each be one or more devices connected to a virtual space service provided by the electronic device 300. The virtual space service provided by the electronic device 300 according to an embodiment of the disclosure may be displayed on the external devices 321, 322, and 323, and a plurality of users may participate the virtual space service by using their external devices 321, 322, and 323.

The external devices 321, 322, and 323 connected to the virtual space service may each display a same virtual space and may be located in different real world spaces. In addition, respective users of the external devices 321, 322, and 323 may be positioned in real world spaces where respective displays are located.

The system according to an embodiment of the disclosure may provide content in a virtual space according to the above-described embodiment of the disclosure. Specific operations of the electronic device 300, the server 310, and the external devices 321, 322, and 323 have been described above, and redundant descriptions are not provided.

The electronic device 300 according to an embodiment of the disclosure may communicate with the server 310. The electronic device 300 may transmit/receive data used in the above-described operations to/from the server 310. In this case, at least part of data processing performed in the above-described operations may be performed by the server 310.

An electronic device for providing content in a virtual space according to an embodiment of the disclosure may include a memory and at least one processor. The memory may store at least one instruction. The at least one processor may execute the at least one instruction stored in the memory.

The at least one processor may execute the at least one instruction to obtain an image including a user. The at least one processor may obtain, from the image, first position information indicating the positions of a plurality of feature points indicating a specific part of the user's body. The at least one processor may check whether a posture of the user included in the image corresponds to a preset response pose, based on the first position information. The at least one processor may determine the content to be provided in the virtual space, based on whether the user's posture corresponds to the preset response pose.

In an embodiment of the disclosure, the at least one processor may obtain second position information indicating the positions of a plurality of feature points indicating a specific part of a posture corresponding to the preset response pose. The at least one processor may check whether the user's posture corresponds to the preset response pose, by comparing the first position information with the second position information.

In an embodiment of the disclosure, the user's body may include the user's upper body.

In an embodiment of the disclosure, the image may include a plurality of images including the user. The at least one processor may obtain respective pieces of first position information from the plurality of images. The at least one processor may obtain average position information based on the respective pieces of first position information. The respective pieces of first position information may include a plurality of position values indicating the positions of a plurality of feature points. The average position information may include an average position value indicating an average position of the plurality of feature points, the average position value being obtained by averaging the plurality of position values. The at least one processor may check whether the user's posture corresponds to a preset response pose, based on the average position information.

In an embodiment of the disclosure, the preset response pose may include at least one of a clapping pose, a cheering pose, an arm-opening pose, a dancing pose, or a one-hand-raising pose.

In an embodiment of the disclosure, the at least one processor may determine the degree of response related to the degree of response of the user to content, based on whether the user's posture corresponds to the preset response pose, and depending on the degree of response of the user, the degree of response may include a first response degree indicating a high level of degree of response and a second response degree indicating a low level of degree of response. When it is checked that the user's posture corresponds to the at least one of the clapping pose, the cheering pose, the arm-opening pose, the dancing pose, or the one-hand-raising pose, the at least one processor may obtain the first response degree, in correspondence to the user's posture. The at least one processor may determine the content to be provided in the virtual space, based on the degree of response.

In an embodiment of the disclosure, when it is checked that the user's posture corresponds to a standby pose, the at least one processor may obtain the second response degree, in correspondence to the user's posture.

In an embodiment of the disclosure, when the user's posture corresponds to the preset response pose, the at least one processor may obtain at least one of a pose variance information, pose count information or pose duration information, which are related to a pose assumed by the user. The at least one processor may determine the degree of response, based on the at least one of the pose variance information, the pose count information, or the pose duration information.

In an embodiment of the disclosure, the at least one processor may obtain a plurality of images respectively including a plurality of users. The at least one processor may obtain a plurality of degrees of response related to the degrees of response of the plurality of users to content, based on the plurality of images. The at least one processor may determine content including at least one image selected from among the plurality of images, based on the plurality of degrees of response.

In an embodiment of the disclosure, the at least one processor may generate a data stream including data about the content, position information of a first region in the content, and the selected at least one image. The at least one processor may transmit the generated data stream to an external device such that the external device may display the content and display the selected at least one image among the plurality of images in the first region in the content.

In an embodiment of the disclosure, the at least one processor may obtain, from the image, link information indicating a relationship between adjacent feature points among the plurality of feature points, based on the first position information. The at least one processor may check whether the posture of the user included in the image corresponds to the preset response pose, based on the link information.

In an embodiment of the disclosure, the plurality of feature points may include a first feature point and a second feature point that are adjacent to each other, and a third feature point adjacent to the second feature point. The at least one processor may obtain first link information about a change in relationship between the first feature point and the second feature point, and second link information about a change in relationship between the second feature point and the third feature point, based on the image. The at least one processor may check whether the user's posture corresponds to the preset response pose, based on a result of applying a first weight value to the first link information and applying a second weight value to the second link information.

A method for providing content in a virtual space, according to an embodiment of the disclosure, may include obtaining an image including a user. The method may include obtaining, from the image, first position information indicating the positions of a plurality of feature points indicating a specific part of the user's body. The method may include checking whether a posture of the user included in the image corresponds to a preset response pose, based on the first position information. The method may include determining the content to be provided in the virtual space, based on whether the user's posture corresponds to the preset response pose.

In an embodiment of the disclosure, the checking of whether the user's posture corresponds to the preset response pose may include obtaining second position information indicating the positions of a plurality of feature points indicating a specific part of a posture corresponding to the preset response pose. The checking of whether the user's posture corresponds to the preset response pose may include checking whether the user's posture corresponds to the preset response pose, by comparing the first position information with the second position information.

In an embodiment of the disclosure, the image may include a plurality of images including the user. The obtaining of the first position information may include obtaining respective pieces of first position information from the plurality of images. The checking of whether the user's posture corresponds to the preset response pose may include obtaining average position information based on the respective pieces of first position information, wherein the respective pieces of first position information may include a plurality of position values indicating the positions of the plurality of feature points, and the average position information may include an average position value indicating an average position of the plurality of feature points, the average position value being obtained by averaging the plurality of position values. The checking of whether the user's posture corresponds to the preset response pose may include checking whether the user's posture corresponds to the preset response pose, based on the average position information.

In an embodiment of the disclosure, the determining of the content may include, when the user's posture corresponds to the preset response pose, obtaining at least one of pose variance information, pose count information or pose duration information, which are related to a pose assumed by the user. The determining of the content may include determining the degree of response related to the degree of response of the user to the content, based on the at least one of the pose variance information, the pose count information, or the pose duration information. The determining of the content may include determining the content to be provided in the virtual space, based on the degree of response.

In an embodiment of the disclosure, the obtaining of the image may include obtaining a plurality of images respectively including a plurality of users. The determining of the content may include determining a plurality of degrees of response related to the degrees of response of the plurality of users to the content, based on the plurality of images. The determining of the content may include obtaining at least one image selected from among the plurality of images, based on the plurality of degrees of response.

In an embodiment of the disclosure, the method may further include generating a data stream including data about the content, position information of a first region in the content, and the selected at least one image. The method may further include transmitting the generated data stream to an external device such that the external device may display the content and display the selected at least one image among the plurality of images in the first region in the content.

In an embodiment of the disclosure, the checking of whether the user's posture corresponds to the preset response pose, based on the first position information, may include obtaining, from the image, link information indicating a relationship between adjacent feature points among the plurality of feature points, based on the first position information. In an embodiment of the disclosure, the checking of whether the user's posture corresponds to the preset response pose, based on the first position information, may include checking whether the posture of the user included in the image corresponds to the preset response pose, based on the link information.

According to an embodiment of the disclosure, provided is a computer-readable recording medium having recorded thereon a program for executing the method, on a computer.

A machine-readable storage medium may be provided in the form of a non-transitory storage medium. In this regard, the term “non-transitory storage medium” merely means that the storage medium is a tangible device, and does not include a signal (e.g., an electromagnetic wave), and this term does not differentiate between a case where data is semi-permanently stored in the storage medium and a case where the data is temporarily stored in the storage medium. For example, the non-transitory storage medium includes a buffer in which data is temporarily stored.

According to an embodiment of the disclosure, the method according to various embodiments disclosed in the specification may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store, or between two user devices (e.g., smartphones) directly. For online distribution, at least a part of the computer program product (e.g., a downloadable app) may be temporarily generated or be at least temporarily stored in a machine-readable storage medium, e.g., a server of a manufacturer, a server of an application store, or a memory of a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device for providing content in a virtual space, the electronic device comprising:
memory storing at least one instruction; and
at least one processor configured to execute the at least one instruction stored in the memory,
wherein the at least one processor executing the at least one instruction cause the electronic device to:
obtain an image including a user,
obtain, from the image, first position information indicating positions of a plurality of feature points indicating a specific part of a body of the user,
check whether a posture of the user included in the image corresponds to a preset response pose, based on the first position information, and
determine the content to be provided in the virtual space, based on whether a posture of the user corresponds to the preset response pose.

2. The electronic device of claim 1, wherein the at least one processor executing the at least one instruction further cause the electronic device to:
obtain second position information indicating positions of a plurality of feature points indicating a specific part of a posture corresponding to the preset response pose, and
check whether the user's posture corresponds to the preset response pose, by comparing the first position information with the second position information.

3. The electronic device of claim 1, wherein the user's body comprises an upper body of the user.

4. The electronic device of claim 1,
wherein the image comprises a plurality of images including the user, and
wherein the at least one processor executing the at least one instruction further cause the electronic device to:
obtain respective pieces of first position information from the plurality of images,
obtain average position information based on the respective pieces of first position information, wherein the respective pieces of first position information comprise a plurality of position values indicating the positions of the plurality of feature points, and the average position information comprises an average position value indicating an average position of the plurality of feature points, the average position value being obtained by averaging the plurality of position values, and
check whether the user's posture corresponds to the preset response pose, based on the average position information.

5. The electronic device of claim 1, wherein the preset response pose comprises at least one of a clapping pose, a cheering pose, an arm-opening pose, a dancing pose, or a one-hand-raising pose.

6. The electronic device of claim 5, wherein the at least one processor executing the at least one instruction further cause the electronic device to:
determine a degree of response related to a degree of response of the user to the content, based on whether the user's posture corresponds to the preset response pose,
wherein the degree of response comprises:
a first response degree indicating a high level of degree of response, and
a second response degree indicating a low level of degree of response,
when it is checked that the user's posture corresponds to the at least one of the clapping pose, the cheering pose, the arm-opening pose, the dancing pose, or the one-hand-raising pose, obtain the first response degree, in correspondence to the user's posture; and
determine the content to be provided in the virtual space, based on the degree of response.

7. The electronic device of claim 6, wherein the at least one processor executing the at least one instruction further cause the electronic device to, when it is checked that the user's posture corresponds to a standby pose, obtain the second response degree, in correspondence to the user's posture.

8. The electronic device of claim 6, wherein the at least one processor executing the at least one instruction further cause the electronic device to:
when the user's posture corresponds to the preset response pose, obtain at least one of pose variance information, pose count information or pose duration information, which are related to the user's posture; and
determine the degree of response, based on the at least one of the pose variance information, the pose count information, or the pose duration information.

9. The electronic device of claim 6, wherein the at least one processor executing the at least one instruction further cause the electronic device to:
obtain a plurality of images respectively including a plurality of users,
determine a plurality of degrees of response related to degrees of response of the plurality of users to the content, based on the plurality of images, and
determine the content comprising at least one image selected from among the plurality of images, based on the plurality of degrees of response.

10. The electronic device of claim 9, wherein the at least one processor executing the at least one instruction further cause the electronic device to:
generate a data stream comprising data about the content, position information of a first region in the content, and the selected at least one image, and
transmit the generated data stream to an external device such that the external device displays the content and displays the selected at least one image among the plurality of images in the first region in the content.

11. The electronic device of claim 1, wherein the at least one processor executing the at least one instruction further cause the electronic device to:
obtain, from the image, link information indicating a relationship between adjacent feature points among the plurality of feature points, based on the first position information, and
check whether the posture of the user included in the image corresponds to the preset response pose, based on the link information.

12. The electronic device of claim 11,
wherein the plurality of feature points comprise a first feature point and a second feature point that are adjacent to each other, and a third feature point adjacent to the second feature point, and
wherein the at least one processor executing the at least one instruction further cause the electronic device to:
obtain first link information indicating a relationship between the first feature point and the second feature point, and second link information indicating a relationship between the second feature point and the third feature point, based on the image, and
check whether the user's posture corresponds to the preset response pose, based on a result of applying a first weight value to the first link information and applying a second weight value to the second link information.

13. A method of providing content in a virtual space, the method comprising:
obtaining an image including a user;
obtaining, from the image, first position information indicating positions of a plurality of feature points indicating a specific part of the user's body;
checking whether a posture of the user included in the image corresponds to a preset response pose, based on the first position information; and
determining the content to be provided in the virtual space, based on whether the user's posture corresponds to the preset response pose.

14. The method of claim 13, wherein the checking of whether the user's posture corresponds to the preset response pose comprises:
obtaining second position information indicating positions of a plurality of feature points indicating a specific part of a posture corresponding to the preset response pose; and
checking whether the user's posture corresponds to the preset response pose, by comparing the first position information with the second position information.

15. The method of claim 13,
wherein the image comprises a plurality of images including the user,
wherein the obtaining of the first position information comprises obtaining respective pieces of first position information from the plurality of images, and
wherein the checking of whether the user's posture corresponds to the preset response pose comprises:
obtaining average position information based on the respective pieces of first position information, wherein the respective pieces of first position information comprise a plurality of position values indicating the positions of the plurality of feature points, and the average position information comprises an average position value indicating an average position of the plurality of feature points, the average position value being obtained by averaging the plurality of position values; and
checking whether the user's posture corresponds to the preset response pose, based on the average position information.

16. The method of claim 13, wherein the determining of the content comprises:
when the user's posture corresponds to the preset response pose, obtaining at least one of pose variance information, pose count information or pose duration information, which are related to the user's posture;
determining a degree of response related to a degree of response of the user to the content, based on the at least one of the pose variance information, the pose count information, or the pose duration information; and
determining the content to be provided in the virtual space, based on the degree of response.

17. The method of claim 13,
wherein the obtaining of the image comprises obtaining a plurality of images respectively including a plurality of users, and
wherein the determining of the content comprises:
determining a plurality of degrees of response related to degrees of response of the plurality of users to the content, based on the plurality of images; and
determining the content comprising at least one image selected from among the plurality of images, based on the plurality of degrees of response.

18. The method of claim 17, further comprising:
generating a data stream comprising data about the content, position information of a first region in the content, and the selected at least one image; and
transmitting the generated data stream to an external device such that the external device displays the content and displays the selected at least one image among the plurality of images in the first region in the content.

19. The method of claim 13, wherein the checking of whether the user's posture corresponds to the preset response pose, based on the first position information, comprises:
obtaining, from the image, link information indicating a relationship between adjacent feature points among the plurality of feature points, based on the first position information; and
checking whether the posture of the user included in the image corresponds to the preset response pose, based on the link information.

20. A non-transitory computer-readable recording medium having recorded thereon a program executed by at least one process to perform a method of providing content in a virtual space, the method comprising operations of:
obtaining an image including a user;
obtaining, from the image, first position information indicating positions of a plurality of feature points indicating a specific part of the user's body;
checking whether a posture of the user included in the image corresponds to a preset response pose, based on the first position information; and
determining the content to be provided in the virtual space, based on whether the user's posture corresponds to the preset response pose.
